(19) United States
(12) Patent Application Publication
(10) Pub. No.: US 2025/0084936 A1
(43) Pub. Date: Mar. 13, 2025

(54) SUPPORT SYSTEM

(71) Applicant: ERICO International Corporation, Solon, OH (US)

(72) Inventors: Steven McDaniel, Burton, OH (US); Jody Seubert, Appleton, WI (US); Eric J. Wilson, Solon, OH (US); Raymond Michael Olle, Valley View, OH (US)

(21) Appl. No.: 18/827,051

(22) Filed: Sep. 6, 2024

Related U.S. Application Data
(60) Provisional application No. 63/581,316, filed on Sep. 8, 2023.
(60) Provisional application No. 63/557,703, filed on Feb. 26, 2024.

(51) Int. Cl. F16L 21/06

(52) U.S. Cl. CPC F16L 21/06

(57) ABSTRACT

A coupler for joining conduit can include a body defining an internal body passage that includes a first open end to receive a first conduit in a first axial insertion direction and a second open end to receive a second conduit in a second axial insertion direction. The body can include a tongue extending from a first axial end of the body in a tongue direction, opposite the first axial insertion direction, to provide a support surface that extends axially away from the first open end of the internal body passage in the tongue direction. The tongue can include a landing surface aligned with a bottom portion of the support surface and wings extending upwardly and laterally outwardly from the landing surface. The tongue can extend around less than a full perimeter of the first open end and the wings extend laterally wider than the first open end.

### CROSS-REFERENCE TO RELATED APPLICATIONS

This application claims priority to and incorporates by reference U.S. provisional patent application Nos. 63/581,316 and 63/557,703, filed Sep. 8, 2023 and Feb. 26, 2024, respectively.

### BACKGROUND

In many applications, it may be useful to suspend equipment such as conduit, pipe, and ducts from a ceiling or sidewall of a building. Suspending the equipment from the ceiling may help to create extra usable space in an interior of the building.

### SUMMARY

A coupler for joining conduit may include a body defining an internal body passage that includes a first open end to receive a first conduit in a first axial insertion direction and a second open end to receive a second conduit in a second axial insertion direction opposite the first axial insertion direction. The body may include a tongue extending from a first axial end of the body in a tongue direction, opposite the first axial insertion direction, to provide a support surface that extends axially away from the first open end of the internal body passage in the tongue direction. The tongue may include a landing surface aligned at a bottom portion of the support surface and wings extending upwardly and laterally outwardly from the landing surface. The tongue may extend around less than a full perimeter of the first open end and the wings extend laterally wider than the first open end.

A coupler for joining conduit may include a body that may include an exterior wall surrounding an internal body passage. The internal body passage may be configured to receive a first conduit from a first open end in a first axial insertion direction and a second conduit from a second open end in a second axial insertion direction. The coupler may further include a tapered entry extending from the first open end. The tapered entry may define an insertion opening that has a greater width than the first open end. In some examples, the tapered entry may extend from the first open end, in a direction opposite the first axial insertion direction, by at least 15% of an axial length of the body.

A method of connecting a first conduit to a second conduit can include connecting the first conduit to a body of a coupler by extending the first conduit into an internal body passage that is defined by the body, with the coupler inserted in a first axial insertion direction into a first open end of the internal body passage at a first axial end of the body. The body may further include a second open end of the internal body passage at a second axial end of the body opposite the first axial end. The second open end may define a second axial insertion direction opposite the first axial insertion direction. The method may include connecting the second conduit to the coupler by resting the second conduit on a landing surface of the coupler that is included on a tongue. The tongue may extend from the second axial end of the body in a tongue direction that is opposite the second axial insertion direction. The method may include connecting the second conduit to the coupler by moving the second conduit from the landing surface in the second axial insertion direction, to extend the second conduit into the internal body passage of the coupler at the second open end. The second conduit may be guided to one or more of the landing surface or the second open end by wings of the coupler that extend upwardly from the landing surface and laterally outwardly from the landing surface to be laterally wider than the second open end.

A coupler for joining conduit may include a body that includes an exterior wall surrounding an internal body passage. The internal body passage may include a first open end to receive a first conduit in a first axial insertion direction and a second open end to receive a second conduit in a second axial insertion direction. The coupler may include a tapered entry may extend from the first open end. The coupler may include a cylindrical insertion passage extending from the tapered entry, opposite the first open end, with a greater internal width than the first open end/The tapered entry may extend from the first open end, in a direction opposite the first axial insertion direction. The insertion passage may extend from the tapered entry, in a direction opposite the first axial insertion direction.

An adapter for a coupler for joining conduit can be provided. The coupler may include an exterior wall surrounding an internal body passage configured to receive a first conduit from a first open end in a first axial insertion direction and a second conduit from a second open end in a second axial insertion direction. The adapter may include a sleeve that defines an internal sleeve passage with a first end configured to receive the first open end of the coupler. The adapter may further include a tapered entry extending from a second end of the sleeve to define an internal tapered passage and an insertion opening that may have a greater width than a width of the internal sleeve passage at the first end.

A coupler for joining conduit may include a body that may include an exterior wall surrounding an internal body passage. The internal body passage may be configured to receive a first conduit from a first open end in a first axial insertion direction and a second conduit from a second open end in a second axial insertion direction. The coupler may further include a tongue extending from a first axial end of the body to provide a landing surface that extends axially away from the first open end of the internal body passage in a tongue direction opposite the first axial insertion direction. The tongue may extend around less than a full circumference of the first open end and may further extend from the first open end, in the tongue direction.

An adapter for a coupler for joining conduit can be provided. The coupler may include an exterior wall surrounding an internal body passage configured to receive a first conduit from a first open end in a first axial insertion direction and a second conduit from a second open end in a second axial insertion direction. The adapter may include a sleeve that defines an internal sleeve passage with a first end configured to receive the first open end of the coupler. The adapter may further include a landing surface extending from a second end of the sleeve. The landing surface may extend along a landing base that extends axially from the second end of the sleeve, and along wings that extend laterally from the landing base to define an open-topped structure.

A coupler for joining conduit may include a body that may include an exterior wall surrounding an internal body passage. The internal body passage may be configured to receive a first conduit from a first open end in a first axial insertion direction and a second conduit from a second open end in a second axial insertion direction. The coupler may further include a tapered entry extending from the first open end. An insertion passage may extend from the tapered entry defining a greater width than the first open end. The tapered entry may extend from the first open end, in a direction opposite the first axial insertion direction. The insertion passage may extend from the tapered entry, in a direction opposite the first axial insertion direction.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a coupler according to an example of the disclosed technology;

FIG. 2 is a bottom plan view of the coupler of FIG. 1;

FIG. 3 is a front plan view of the coupler of FIG. 1;

FIG. 4 is an axonometric view of an adapter retaining a coupler according to an example of the disclosed technology;

FIG. 5 is a side plan view of the adapter of FIG. 4 retaining the coupler;

FIG. 6 is a front plan view of the adapter of FIG. 4 retaining the coupler;

FIG. 7 is a cross-sectional view of the adapter of FIG. 4 retaining the coupler;

FIG. 8 is an axonometric view of an adapter according to an example of the disclosed technology;

FIG. 9 is an exploded axonometric view of the adapter of FIG. 8;

FIG. 10 is an axonometric view of an adapter according to an example of the disclosed technology;

FIG. 11 is an axonometric view of a first adapter body of the adapter of FIG. 10;

FIG. 12 is an axonometric view of an adapter according to an example of the disclosed technology;

FIG. 13 is a bottom axonometric view of the adapter of FIG. 12 partially open;

FIGS. 14 and 15 are axonometric views of adapter bodies of the adapter of FIG. 12;

FIG. 16 is an axonometric view of the adapter of FIG. 12 retaining a coupler.

FIG. 17 is an axonometric view of a coupler according to an example of the disclosed technology;

FIG. 18 is a cross-sectional view of the adapter of FIG. 17;

FIG. 19 is an axonometric view of an adapter according to an example of the disclosed technology;

FIG. 20 is a cross-sectional view of the adapter of FIG. 19 retaining a coupler;

FIG. 21 is an axonometric view of a coupler according to an example of the disclosed technology;

FIG. 22 is a front plan view of the coupler of FIG. 21;

FIG. 23 is a cross-sectional view of the adapter of FIG. 22;

FIG. 24 is an axonometric view of an adapter retaining a coupler according to an example of the disclosed technology;

FIG. 25 is a front plan view of the adapter of FIG. 24;

FIG. 26 is a cross-sectional view of the adapter of FIG. 24 retaining the coupler;

FIG. 27 is an axonometric view of an adapter according to an example of the disclosed technology;

FIG. 28 is a front plan view of the adapter of FIG. 27;

FIG. 29 is an axonometric view of the adapter of FIG. 28 in an open configuration;

FIG. 30 is an axonometric view of a coupler according to an example of the disclosed technology;

FIG. 31 is a front plan view of the coupler of FIG. 30;

FIG. 32 is a side axonometric view of the coupler of FIG. 30;

FIG. 33 is an axonometric view of a coupler according to an example of the disclosed technology;

FIG. 34 is a front plan view of the coupler of FIG. 33;

FIG. 35 is a side axonometric view of the coupler of FIG. 33;

FIG. 36 is an axonometric view of a coupler according to an example of the disclosed technology;

FIG. 37 is a front plan view of the coupler of FIG. 36;

FIG. 38 is a side axonometric view of the coupler of FIG. 36;

FIG. 39 is an axonometric view of a coupler according to an example of the disclosed technology;

FIG. 40 is a front plan view of the coupler of FIG. 39; and

FIG. 41 is a side axonometric view of the coupler of FIG. 39.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to suspend equipment (e.g., conduit, pipe, and ducts) above the ground in buildings. Multiple lengths of such equipment are often run side by side and collectively suspended from a ceiling or other overhead support structure. Conventional configurations of such support systems can require the conduit to be suspended using horizontal support struts that are threadedly connected to a ceiling, via a hanger bar. In particular, standardized strut is typically used, including a straight horizontal bar with an internal track for receiving one or more clamps, couplers, or other components. When installing the couplers, it can be advantageous to align couplers on separate support struts that are receiving the same length of conduit or pipe, to allow for easier installation and alignment of the conduit or pipe. In some instances, the couplers may be slightly misaligned, or the conduit may not be perfectly straight. Thus, attempting to coordinate installation of a length of conduit across multiple support struts can be a challenging and time-consuming process with many laborious adjustments.

Embodiments of the present invention may address these and other issues, including with coupler and adapter designs that can significantly reduce installation time for equipment support systems (e.g., to support conduit, pipe, and ducts). For example, the use of a tapered coupler or coupler adapter according to the disclosed technology can reduce the need for the manual realignment of one or more clamps along a length of strut during installation. Using a tapered coupler or coupler adapter as disclosed may also allow prefabricators further room to accommodate dimensional, alignment and other errors during prefabrication operations for conduit support systems and other installations.

In some embodiments, a coupler for joining together conduit can include a conduit passage to receive conduit into opposing open ends, and a tapered entry extending from a first open end. The tapered entry can define an insertion opening that has a greater width than the first open end, including with diameters (or effective diameters) that exceed by the first open end by 15% or more. Such a tapered entry may usefully guide the end of a length of conduit into the coupler during installation. In particular examples, the tapered entry may aid workers attempting to bend non-straight conduit into proper alignment. In some arrangements, the tapered entry may further aid workers attempting to install lengths of conduit into misaligned couplers (e.g., as secured within a larger support assembly).

In some embodiments, a coupler for joining together conduit can include a conduit passage to receive conduit into opposing open ends, and a tongue extending from a first open end. The tongue can define a landing surface that has a greater width than the first open end of the coupler. Such a tongue may usefully guide the end of a length of conduit into the coupler during installation. In particular examples, during installation of the conduit into the first open end of the coupler, the tongue may support the weight of the conduit relative to gravity to allow installers to focus strength and concentration on pushing the conduit axially into a final installed position within the coupler. The tongue may also aid workers attempting to bend non-straight conduit into proper alignment. In some arrangements, the tongue may further aid workers attempting to install lengths of conduit into misaligned couplers (e.g., as secured within a larger support assembly).

In some embodiments, a tapered entry or a tongue may be provided on a component that is not integrally formed with the coupler. For example, a tapered entry or a tongue may extend from an adapter configured to be coupled to a first open end of a coupler. The adapter may include a sleeve that defines an internal sleeve passage that receives a corresponding end of a coupler (e.g., with the coupler telescopically nested within the sleeve passage). The tapered entry or the tongue of the adapter may thus be configured to assist users in guiding the conduit easily into the attached coupler. In such examples, the adapter may be installed over the coupler to aid workers in the alignment and installation of conduit into the couplers.

In some embodiments, an adapter can include a first adapter body and a second adapter body that are configured to be removably secured together to define a sleeve passage. In some embodiments, the first adapter body or the second adapter body may include a latch or tab that may aid the removal of the first adapter body from the second adapter body. In some examples, the first adapter body and the second adapter body may be hingedly connected. In such examples, the removable first adapter body and second adapter body may allow the worker to remove and reuse the sleeve to aid in the installation of more than one length of conduit.

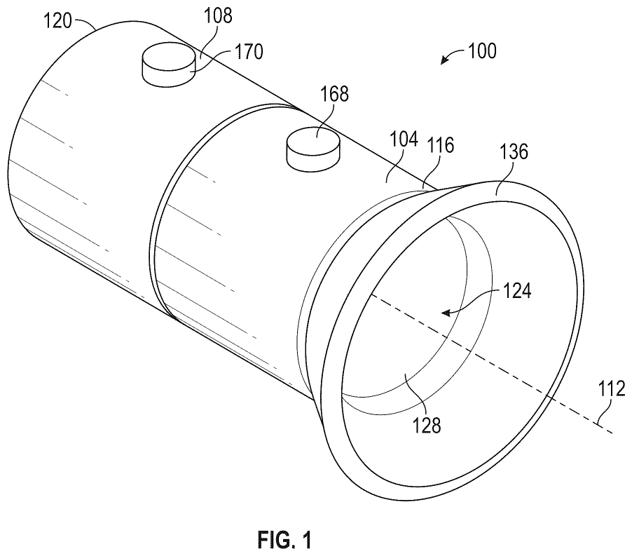

As one example, FIGS. 1-3 illustrate a coupler 100 for receiving and retaining a length of conduit (not shown) or other elongate structure upon a length of strut (not shown) or other support structure. In the illustrated example, the coupler 100 may include a body 104 that includes an exterior wall 108. In some embodiments, the body 104 may be cylindrically shaped. The body 104 may include a coupler center axis 112 extending from a center (or centroid) of a first coupler end 116 of the body 104 to a center (or centroid) of a second coupler end 120, opposite the first coupler end 116. The exterior wall 108 may surround an internal body passage 124. The internal body passage 124 may extend axially relative to the coupler center axis 112, from the first coupler end 116 to the second coupler end 120.

The internal body passage 124 may define a first open end 128, at the first coupler end 116, and a second open end 132, at the second coupler end 120. In some embodiments, the first open end 128 and the second open end 132 may each be configured to receive a respective length of conduit (not shown). A first length of conduit (not shown) may be inserted axially along the coupler center axis 112 into the first open end 128 in a first insertion direction. A second length of conduit (not shown) may be inserted axially along the coupler center axis 112 into the second open end 132 in a second insertion direction (e.g., opposite the first insertion direction, in the example shown). In some examples, the “second” length of conduit as described above may be inserted into the internal body passage 124 first in time, followed by the “first” length of conduit as described above.

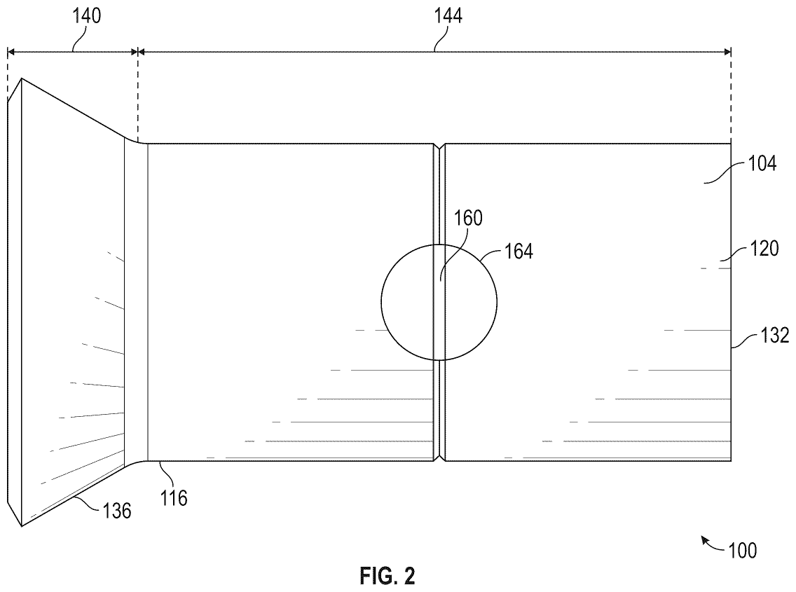

Referring still to FIGS. 1-3, the coupler 100 may include a tapered entry 136. The tapered entry 136 may extend axially from the first coupler end 116. The tapered entry 136 may extend in a direction opposite the first insertion direction. The tapered entry 136 may flare as it extends from the first coupler end 116. The tapered entry 136 may be conical in shape. As shown in FIG. 2, in particular, the tapered entry 136 may extend from the first coupler end 116 by a length 140 that is about 19% of an axial length 144 of the body 104 (as measured at a bend between the tapered entry and the internal passage 124). In particular examples, the tapered entry 136 may extend from the first coupler end 116 with the length 140 at least about 15% of the axial length 144 of the body 104. Even more particularly, an optimal balance between reach and total footprint can be provided in some cases with the length 140 between about 10% (or about 15%) and about 25%, inclusive, of an axial length 144 of the body 104.

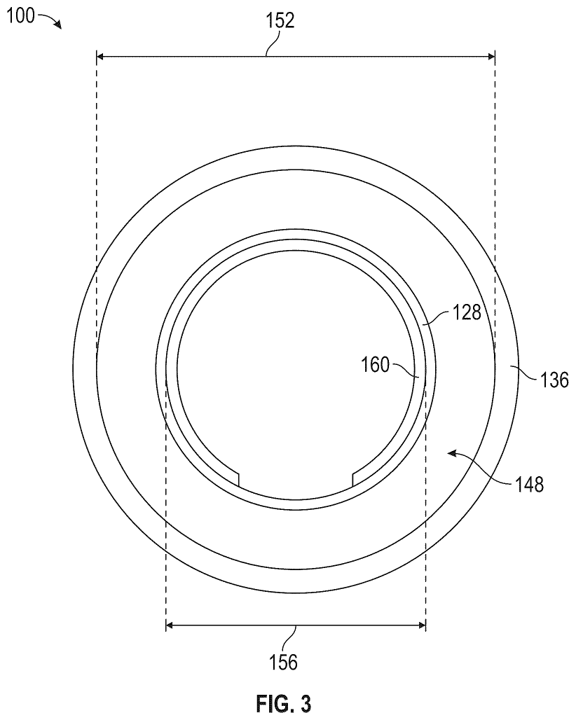

As shown in FIG. 3, in particular, the tapered entry 136 may define an insertion opening 148 for the insertion of the first length of conduit (not shown) in the first insertion direction. The insertion opening 148 may define an entry (inner) diameter 152 that is larger than an opening (inner) diameter 156 of the first open end 128. In some embodiments, the entry diameter 152 may be about 53% larger than the opening diameter 156. In some embodiments, the entry diameter 152 may be more than about 50% larger than the opening diameter 156. In some embodiments, the entry diameter 152 may be larger than the opening diameter 156 by between about 20% (or about 45%) and about 60%, inclusive. As described above, the entry diameter 152 of the tapered entry 136 being larger than the opening diameter 156 of the first open end 128 may help guide the insertion of the first length of conduit (not shown) into the coupler 100 during installation. In some examples, angles corresponding to the noted ranges of the length 144 and the diameter 152 can also provide similarly beneficial arrangements.

During installation, it can be advantageous to align insertion openings of two or more couplers (not shown) arranged on a strut or other support structure (not shown) on a same radial plane relative to insertion axes of the two or more couplers. In some embodiments, an axial length of a body may vary depending on a size of an opening diameter of a first end of the body. For example, a coupler including a relatively larger opening diameter may also include the body having a relatively longer axial length. In some embodiments, in order to ensure the insertion openings of two or more couplers (not shown) are aligned during installation, a length of a tapered entry of each coupler (not shown) or other extension may vary depending on a size of the opening diameter of each of the couplers.

Referring to FIGS. 2 and 3, in particular, the coupler 100 may include a coupler shoulder 160. The coupler shoulder 160 may extend circumferentially around the internal body passage 124. The coupler shoulder 160 may be configured to provide a contact stop for the first length of conduit (not shown) inserted in the first insertion direction, and the second length of conduit (not shown) inserted in the second direction. The coupler shoulder 160 may be disposed about halfway between the first coupler end 116 and the second coupler end of the coupler 100. In the illustrated example, the coupler shoulder 160 is annular in shape, but extends over only a portion of the inner circumference of the body passage 124. In other example, other shapes and amounts of circumferential extensions are possible.

In some embodiments, as shown in FIG. 2, the coupler 100 may include an inspection opening 164. The inspection opening 164 may extend radially through the exterior wall 108 to the internal body passage 124 to provide visual access to the first and second conduit (not shown) installed within the internal body passage 124. The inspection opening 164 may therefore allow an installer to visually verify that an end of the first and second conduit (not shown) are properly inserted within the internal body passage 124, contacting the coupler shoulder 160. In some embodiments, the inspection opening 164 may intersect the coupler shoulder 160. In some embodiments, the coupler 100 may include multiple inspection openings (not shown). For example, a second inspection opening (not shown) may be disposed radially opposing the inspection opening 164. In other examples, the coupler 100 may include two or more inspection openings (not shown), each providing visual access to one or more of the first and second conduit (not shown) installed within the internal body passage 124. Providing more than one inspection opening may allow the coupler 100 to be installed in various different orientations.

In some embodiments, as shown in FIG. 1, the coupler 100 may include one or more fasteners 168 (e.g., two threaded fasteners, as schematically shown). The one or more fasteners 168 may extend through a set of fastener holes 170 in the exterior wall 108 into the internal body passage 124, to aid in the securing of the first and second lengths of conduit (not shown), within the internal body passage 124. In some embodiments, the coupler 100 may include multiple sets of fastener holes (not shown). For example, two sets of fastener holes (not shown) may be disposed radially opposing one another, to allow the coupler 100 to be installed in various different orientations.

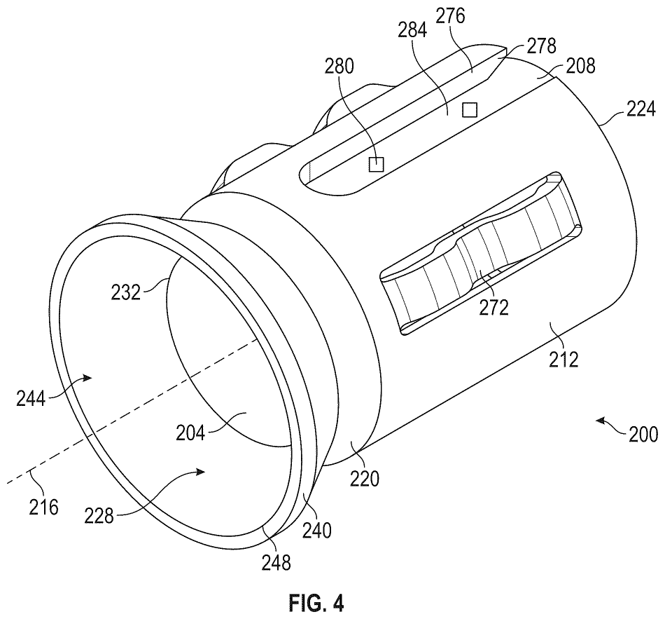

As described above, in some embodiments, the tapered entry may be non-integral with the coupler. In some embodiments, the tapered entry may extend from an adapter configured to be inserted onto or over the coupler. For example, FIGS. 4-7 illustrate an adapter 200 configured to be inserted over a first coupler end 204 of a coupler 208 (e.g., a coupler similar to the coupler 100, without the tapered entry 136).

In the illustrated example, the adapter 200 may include a sleeve 212 that receives a coupler to secure the adapter 200 to the coupler. In some embodiments, the sleeve 212 may be cylindrically shaped. The sleeve 212 may include a sleeve center axis 216 extending through a center (or centroid) of a first sleeve end 220 and a center (or centroid) of a second sleeve end 224, opposite the first sleeve end 220. The sleeve 212 may surround an internal sleeve passage 228. The internal sleeve passage 228 may extend axially relative to the sleeve center axis 216, from the first sleeve end 220 to the second sleeve end 224.

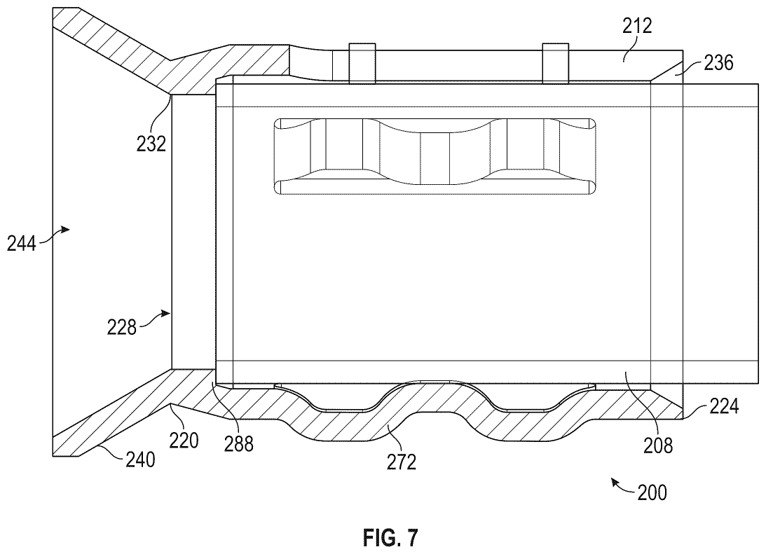

The internal sleeve passage 228 may define a first open sleeve end 232, at the first sleeve end 220, and a second open sleeve end 236, at the second sleeve end 224. In some embodiments, the first open sleeve end 232 may be configured to receive the length of conduit while the second open sleeve end 236 (see FIG. 7) may be configured to receive the coupler 208. Thus, for example, a first length of conduit (not shown) may be inserted axially along the sleeve center axis 216 into the first open sleeve end 232 in the first insertion direction. In contrast, the coupler 208 may be inserted axially along the sleeve center axis 216 into the second open sleeve end 236 in the second insertion direction, opposite the first insertion direction. Thus, for example, the coupler 208 can be held by the internal sleeve passage 228 in alignment to receive a length of conduit inserted through the first open sleeve end 232. In some embodiments, the second open sleeve end 236 may be tapered to provide a guide for installers inserting the coupler 208 into the second open sleeve end 236.

Referring still to FIGS. 4-7, the adapter 200 may include a tapered entry 240 to help guide conduit for insertion into the coupler 208, similarly to the tapered entry 136 described above. The tapered entry 240 may extend axially from the first sleeve end 220. The tapered entry 240 may extend in a direction opposite the first insertion direction. The tapered entry 240 may flare as it extends from the first sleeve end 220. The tapered entry 240 may be conical in shape. The tapered entry 240 may include an internal tapered passage 244 that tapers from an insertion opening 248 to the first open sleeve end 232. In some examples, the tapered entry 240 may exhibit the same particular or relative geometry as the tapered entry 136 (and vice versa).

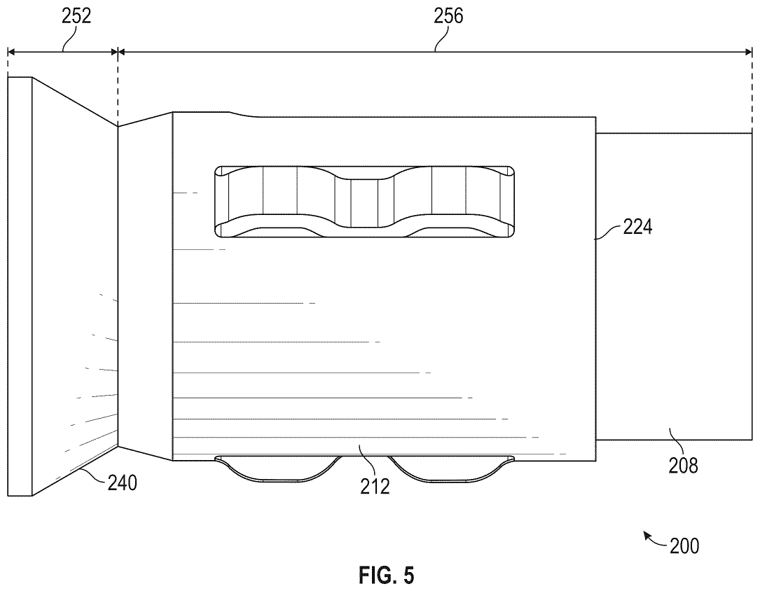

As illustrated in FIG. 5, a distance 252 between the insertion opening 248 and the first sleeve end 220 (or between an edge of the tapered entry 240 and the sleeve end 220) may be about 30% of an axial length 256 of the coupler 208. In some embodiments, the distance 252 between the insertion opening 248 and the first sleeve end 220 may be at least about 25% of the axial length 256 of the coupler 208. In some embodiments, the distance 252 between the insertion opening 248 and the first sleeve end 220 may be between about 10% (or about 15% or about 20%) and about 40%, inclusive, of an axial length 256 of the coupler 208.

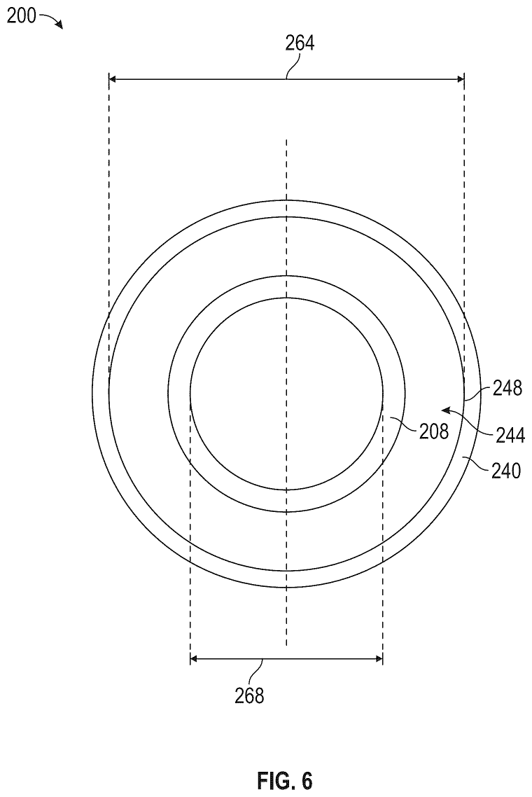

As further examples, referring to FIG. 6, the tapered entry 240 of the adapter 200 may define the insertion opening 248 for the insertion of the first length of conduit (not shown) in the first insertion direction. The insertion opening 248 may define an insertion (inner) diameter 264 that is larger than an opening (inner) diameter 268 of the coupler 208. In some embodiments, the insertion diameter 264 may be about 2.45 times greater of the opening diameter 268. In some embodiments, the insertion diameter 264 may be more than about 2.35 times greater than the opening diameter 268. In some embodiments, the insertion diameter 264 may be between about 1.20 (or about 1.50 or about 2.30) and about 2.60, inclusive, times greater than the opening diameter 268. The insertion diameter 264 of the tapered entry 240 that is larger than the opening diameter 268 of the coupler 208 may aid in guiding the insertion of the first length of conduit (not shown) into the coupler 208 during installation.

As described above, it can be advantageous to align insertion openings of two or more adapters (not shown) arranged on couplers (not shown) on a strut or other support structure (not shown) on a same radial plane relative to insertion axes of the two or more couplers. As also described above, in some embodiments, a length of a tapered entry of each adapter (not shown) may vary depending on a size of the opening diameter of each of the couplers (not shown).

Referring again to FIG. 4, the sleeve 212 may include one or more spring features 272 disposed along the sleeve 212. The spring features 272 may extend axially along the sleeve 212. The spring features 272 may project into the internal sleeve passage 228 in a rest orientation. In some embodiments, the spring features 272 may be leaf springs, angled tabs, biased tab, or other elastically deformable protrusions. The spring features 272 that are leaf springs may be cantilevered leaf springs or may be anchored at opposing ends. The spring features 272 may project into the internal sleeve passage 228 to aid in the retention of the coupler 208, inserted through the second sleeve end 224. As best illustrated in FIG. 7, the spring features 272 may contact an exterior surface of the coupler 208, to aid in the retention of the coupler 208.

Still referring to FIG. 4, the sleeve 212 may include an elongate slot 276. The elongate slot 276 may extend from an exterior of the sleeve 212 to the internal sleeve passage 228. The elongate slot 276 may define a slot entrance 278 at the second sleeve end 224. The elongate slot 276 may extend axially from the second sleeve end 224, toward the first sleeve end 220. The elongate slot 276 may be configured to receive fasteners 280 coupled to a body 284 of the coupler 208. In some embodiments, the elongate slot 276 may receive the fasteners 280 during insertion of the sleeve 212 over the coupler 208. In other embodiments, the fasteners 280 may be installed through the elongate slot 276 after the sleeve 212 is inserted over the coupler 208.

As illustrated in the cross-section of the adapter 200 in FIG. 7, the internal sleeve passage 228 may include a sleeve shoulder 288. The sleeve shoulder 288 may extend circumferentially (e.g., entirely) around the internal sleeve passage 228. The sleeve shoulder 288 may be disposed proximate the first sleeve end 220. The sleeve shoulder 288 may be axially offset from the first sleeve end 220. The sleeve shoulder 288 may provide a contact stop for the first coupler end 116 (the coupler 208 is illustrated as partially transparent). The sleeve shoulder 288 may help to prevent over insertion of the coupler 208 through the second sleeve end 224.

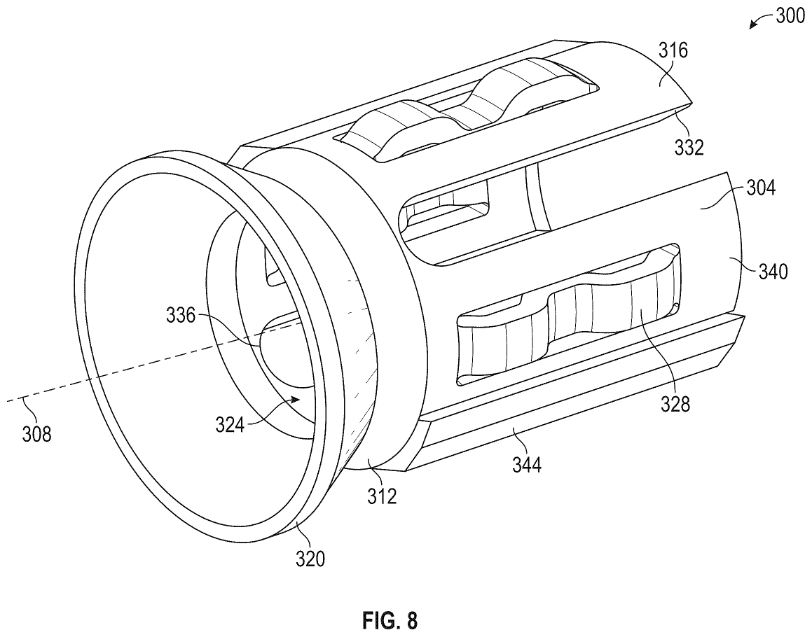

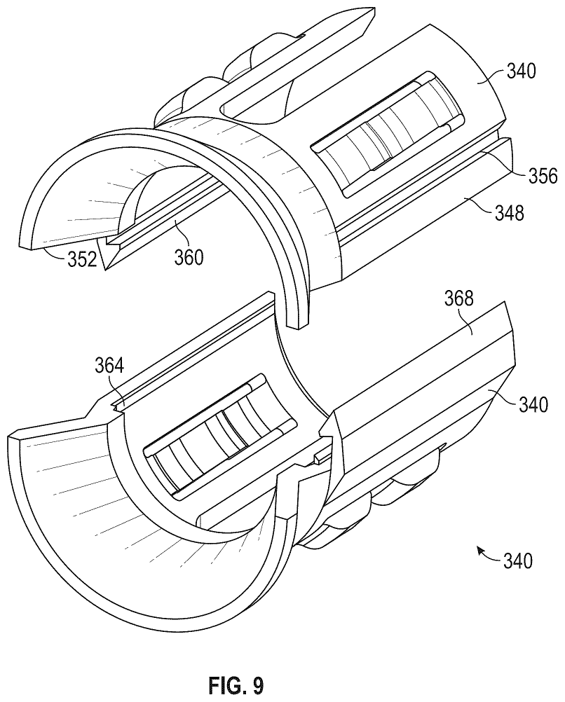

In some configurations, a multi-piece adapter (e.g., flared adapter) can be configured to be installable around and removable from a conduit coupler. In this regard, for example, FIGS. 8 and 9 illustrate another embodiment of an adapter 300. The adapter 300 of FIGS. 8 and 9 may generally include similar features as the adapter 200 of FIGS. 4-7, including but not limited to a sleeve 304, a sleeve center axis 308, a first sleeve end 312, a second sleeve end 316, a tapered entry 320, an internal sleeve passage 324, one or more spring features 328, and one or more elongate slots. Thus, discussion of the adapter 200 above also generally applies to similar components of the adapter 300 (and vice versa).

In some aspects, the adapters 200 and 300 may differ. For example, the adapter 300 of FIGS. 8 and 9 includes a first elongate slot 332 extending from the second sleeve end 316 toward the first sleeve end 312. Further, a second elongate slot 336 may be disposed radially opposite the first elongate slot 332, to allow the adapter 300 to be installed on a coupler (not shown) in two different orientations.

Also distinctly from the illustrated configuration of the adapter 200, the adapter 300 illustrated in FIGS. 8 and 9 may further include a first adapter body 340 and a second adapter body 344. In particular, the first adapter body 340 and the second adapter body 344 are configured to be removably secured together. In some configurations, the first adapter body 340 may be a first half of the adapter 300. In some embodiments, the first adapter body 340 may be substantially identical to the second adapter body 344, with discussion of either one of the adapter bodies 340, 344 herein thus applying equal to the other. In some embodiments, the first adapter body 340 may be dissimilar to the second adapter body 344 (e.g., as discussed relative to other examples below). In some embodiments, the first adapter body 340 may include first portions of the sleeve 304 and the tapered entry 320. Furthermore, the second adapter body 344 may include second portions of the sleeve 304 and the tapered entry 320.

In different examples, different connection structures can be used to secure adapter bodies together, including various snap-fit structures. As illustrated in FIG. 9, in particular, the first adapter body 340 may include a first edge 348 and a second edge 352 extending axially from the second sleeve end 316 (see FIG. 8) to an end of the tapered entry 320. In some embodiments, the first edge 348 may be radially opposite the second edge 352 (e.g., as shown). In some embodiments, the first edge 348 may not be radially opposite the second edge 352.

In some embodiments, the first adapter body 340 may include a snap recess 356 extending axially along an exterior of the sleeve 304 from the first sleeve end 312 to the second sleeve end 316. The snap recess 356 may be circumferentially offset from the first edge 348. In some embodiments, the first adapter body 340 may include a snap hook 360 extending axially along an exterior of the sleeve 304 from the first sleeve end 312 to the second sleeve end 316. The snap hook 360 may extend circumferentially from the second edge 352. In some embodiments, the snap hook 360 may be disposed radially opposite the snap recess 356 (e.g., as shown). In some embodiments, the snap hook 360 may not be disposed radially opposite the snap recess 356. In some embodiments, the snap hook 360 or the snap recess 356 may be axially discontinuous. In some embodiments, the snap hook 360 or the snap recess 356 may be axially continuous (e.g., as shown).

When installed (e.g., connected as shown in FIG. 8), the snap hook 360 of the first adapter body 340 may snap into a second snap recess 364 of the second adapter body 344 (e.g., substantially identical to the snap recess 356). Similarly, a second snap hook 368 of the second adapter body 344 (e.g., substantially identical to the snap hook 360) may snap into the snap recess 356 of the first adapter body 340. The first adapter body 340 may therefore be coupled to the second adapter body 344 to secure a coupler (not shown) and guide a conduit into the coupler. In some embodiments, the first adapter body 340 may be coupled to the second adapter body 344 via compression fit, snap-fit, hook and loop fasteners, hook fasteners, or any other method known for removably securing two bodies together.

In some embodiments, the first adapter body 340 may be swiftly decoupled from the second adapter body 344 using a flat head tool (e.g., a flat-head screwdriver, not shown). In some embodiments, workers may be able to quickly align and insert multiple lengths of conduit into multiple couplers (not shown), by repeatedly sliding the adapter 300 over the coupler (not shown), inserting the conduit (not shown) into the coupler (not shown) through the adapter 300, and finally decoupling the first adapter body 340 from the second adapter body 344 once the conduit is properly secured within the coupler (not shown). In this regard, removable (and reusable) adapters may substantially reduce waste of resources for building installations that may include hundreds to thousands of coupler runs.

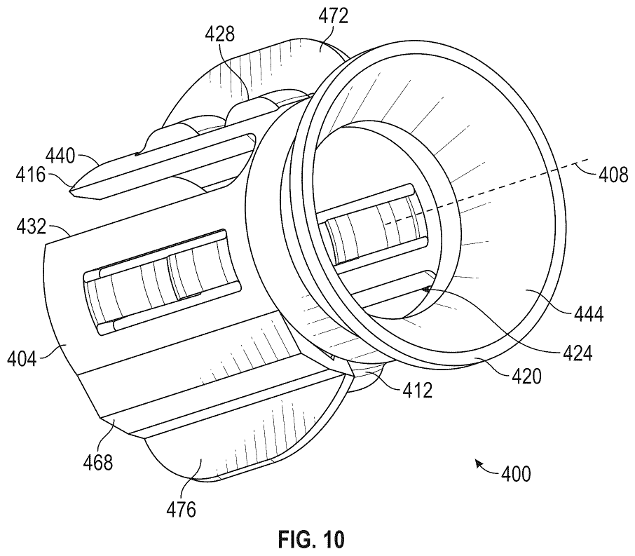

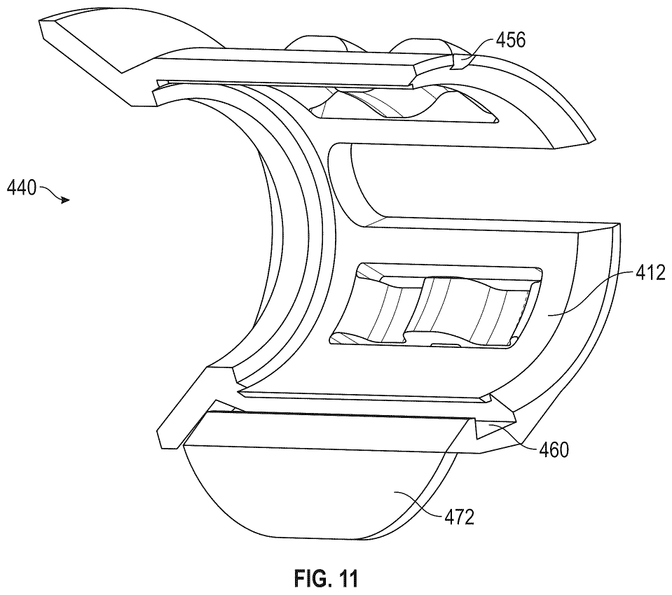

In some examples, protrusions or other features can be included to assist users in removing adapters from couplers. In this regard, for example, FIGS. 10 and 11 illustrate another embodiment of an adapter 400. The adapter 400, shown assembled in FIG. 10, may generally include similar features to the adapter 300 of FIGS. 8 and 9, including but not limited to a sleeve 404, a sleeve center axis 408, a first sleeve end 412, a second sleeve end 416, a tapered entry 420, an internal sleeve passage 424, one or more spring features 428, one or more elongate slots 432, a first adapter body 440, a second adapter body 444, a snap recess 456, a snap hook 460, a second snap recess (not visible in FIGS. 8 and 9), and a second snap hook 468. Thus, discussion of the adapter 300 above also generally applies to similar components of the adapter 400 (and vice versa).

The adapter 400 illustrated in FIG. 10 may further include a first protruding tab 472 extending from the sleeve 404 of the first adapter body 440. In some embodiments, the adapter 400 may also include a second protruding tab 476 extending from the sleeve of the second adapter body 444. In some embodiments, the first protruding tab 472 may be disposed radially opposite the second protruding tab 476. In some embodiments, the first protruding tab 472 may not be disposed radially opposite the second protruding tab 476. The first protruding tab 472 may extend from an edge of the snap hook 460. Similarly, the second protruding tab 476 may extend from an edge of the second snap hook 468. In some embodiments, the first protruding tab 472 or the second protruding tab 476 may extend substantially radially from the sleeve 404.

In some embodiments, the first protruding tab 472 or the second protruding tab 476 may aid in the manual release of a snap engagement (e.g., a snap engagement as described above regarding the adapter 300). Specifically in some embodiments, exerting a force on the first protruding tab 472 in a generally circumferential direction (e.g., tangential to the sleeve 404) may decouple the snap hook 460 from the second snap recess (not visible in FIG. 10). Similarly, exerting a force on the second protruding tab 476 in a generally circumferential direction (e.g., tangential to the sleeve 404) may decouple the second snap hook 468 from the snap recess 456. Alternatively, or additionally, the first or second protruding tabs 472, 476 may be pulled or otherwise gripped to decouple the snap hooks 460, 468 from the corresponding snap recesses (e.g., the recess 456, as shown in FIG. 11).

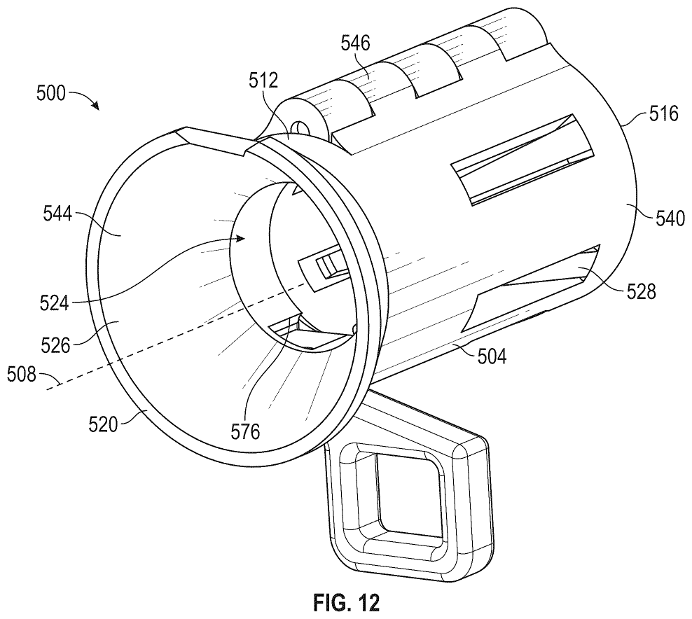

FIGS. 12-16 illustrate another embodiment of an adapter 500. The adapter 500 of FIGS. 12-16. May include generally include similar features to the adapters 300, 400 presented above, including but not limited to a sleeve 504, a sleeve center axis 508, a first sleeve end 512, a second sleeve end 516, a tapered entry 520, an internal sleeve passage 524, an internal tapered passage 526, one or more spring features 528, a sleeve shoulder 532, an elongate slot 536, a first adapter body 540, and a second adapter body 544. Thus, discussion of the adapters 300, 400 above also generally applies to similar components of the adapter 500 (and vice versa).

The adapter 500 illustrated in FIGS. 12-16 may further include a hinge 546 connecting the first adapter body 540 and the second adapter body 544. A first edge 548 of the first adapter body 540 may extend axially from the second sleeve end 516 to an end of the tapered entry 520. A third edge 552 of the second adapter body 544 may extend axially from the second sleeve end 516 to the end of the tapered entry 520. A first portion of the hinge 546 may extend from the first edge 548. A second portion of the hinge 546 may extend from the third edge 552. The hinge 546 may connect the first edge 548 to the third edge 552, to allow the adapter 500 to hingedly open and close.

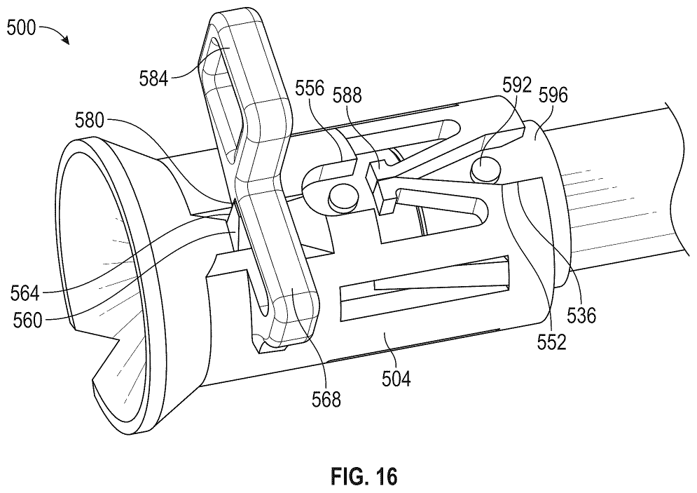

In some embodiments, as illustrated in FIGS. 12-14 the hinge 546 may be a butt hinge held together by a hinge pin 554. In such examples, each half of the hinge 546 may be integrally formed with one of the first adapter body 540 or the second adapter body 544. In some embodiments, the hinge 546 may be a living hinge. In some embodiments, the hinge 546 may be other types of hinges known in the art. Further, in some embodiments, a notch or other cutout can be provided on the tapered entry 520 (see FIGS. 12 and 16) to provide clearance for hinging movement of the adapter bodies 540, 544 relative to each other.

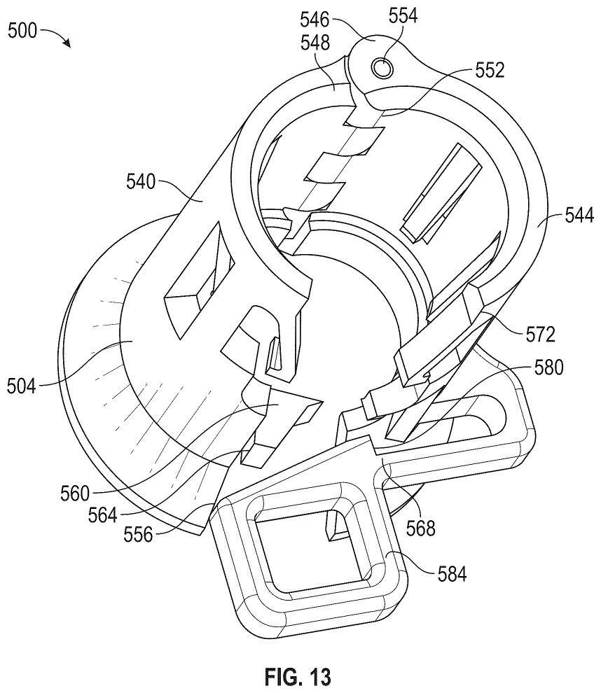

Referring specifically to FIG. 15, a second edge 556 of the first adapter body 540 may extend axially from the second sleeve end 516 to an end of the tapered entry 520. The second edge 556 may be disposed radially opposite the first edge 548 (e.g., as shown). In some embodiments, the second edge 556 may not be disposed radially opposite the first edge 548. A catch 560 may extend from the second edge 556. The catch 560 may extend circumferentially from the second edge 556. The catch 560 may also extend radially from the second edge 556 and in particular may protrude proud of an outer portion of the sleeve 504. In some embodiments, the catch 560 may be axially offset from the first sleeve end 512 of the sleeve 504 (see FIG. 12). In some embodiments, the catch 560 may intersect the sleeve shoulder 532. As described below, a first face 564 of the catch 560 that extends from the second edge 556 radially away from the sleeve center axis 508 may be configured to engage a latch 568 (as shown in FIG. 13).

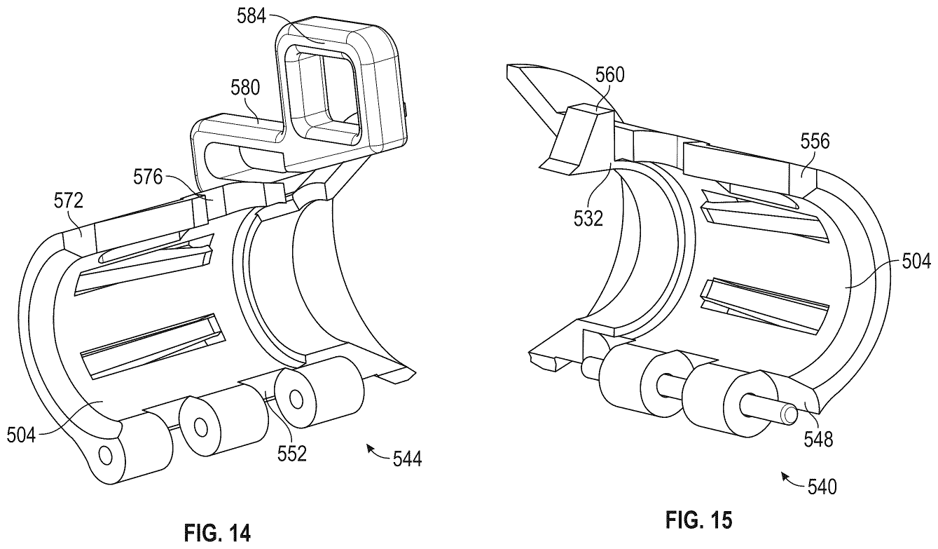

Referring specifically to FIG. 14, a fourth edge 572 of the second adapter body 544 may extend axially from the second sleeve end 516 to the end of the tapered entry 520. In some embodiments the fourth edge 572 may be disposed radially opposite the third edge 552. In some embodiments, the fourth edge 572 may not be disposed radially opposite the third edge 552. A catch recess 576 may be disposed along the fourth edge 572 adjacent the first sleeve end 512 or adjacent to the latch 568.

The catch recess 576 may be configured to receive the catch 560, as illustrated in FIG. 12. In some embodiments, the latch 568 may curve, to extend over the catch recess 576. In some embodiments, the latch 568 may include a second face 580 that extends radially from the latch 568 toward the sleeve center axis 508. As illustrated in FIG. 16, the first face 564 of the catch 560 may engage the second face 580 of the latch 568. The engagement of the latch 568 and the catch 560 may secure the first adapter body 540 and the second adapter body 544 together. Thus, secured together, the first adapter body 540 and the second adapter body 544 may accordingly form the internal sleeve passage 524 and the internal tapered passage 526.

Referring to again to FIGS. 12-16, the latch 568 may include a grip 584. In some embodiments, the grip 584 may be shaped as an eyelet (as shown) or include other grippable geometry. In other embodiments, the grip 584 may be any variety of other shapes. In some embodiments, the grip 584 may extend away from the second face 580. In some embodiments, exerting a pulling force the grip 584 may release the latch 568 from the catch 560.

In some examples, once the length of conduit is properly installed within the coupler (not shown), an installer may pull the latch 568, via the grip 584, to remove the adapter 500. As the first adapter body 540 and the second adapter body 544 are connected via the hinge 546, the adapter 500 may be removed and installed as a singular piece, reducing the complexity of installation and removal. The adapter 500 may advantageously be installed and removed with a single hand, allowing a worker to engage in other tasks with an offhand while working.

Referring to FIG. 16, as described above in relation to FIG. 8, the elongate slot 536 may be disposed along the sleeve 504, extending axially from the second sleeve end 516 toward the first sleeve end 512. In the illustrated embodiment, the elongate slot 536 may be disposed between the second edge 556 of the first adapter body 340, and the fourth edge 572 of the second adapter body 544.

In some embodiments, one or more spring arms 588 may be arranged along the elongate slot 536. In some embodiments, the spring arms 588 may extend from the second edge 556 and the fourth edge 572. In some embodiments, the spring arms 588 may extend at a non-axial angle from second edge 556 and the fourth edge 572 (i.e., obliquely relative to a direction parallel with the axial direction of the adapter 500). The spring arms 588 may be configured to engage one or more fasteners 592 protruding from a coupler 596 retained by the adapter 500. The spring arms 588 may aid the retention of the coupler 596 within the adapter 500.

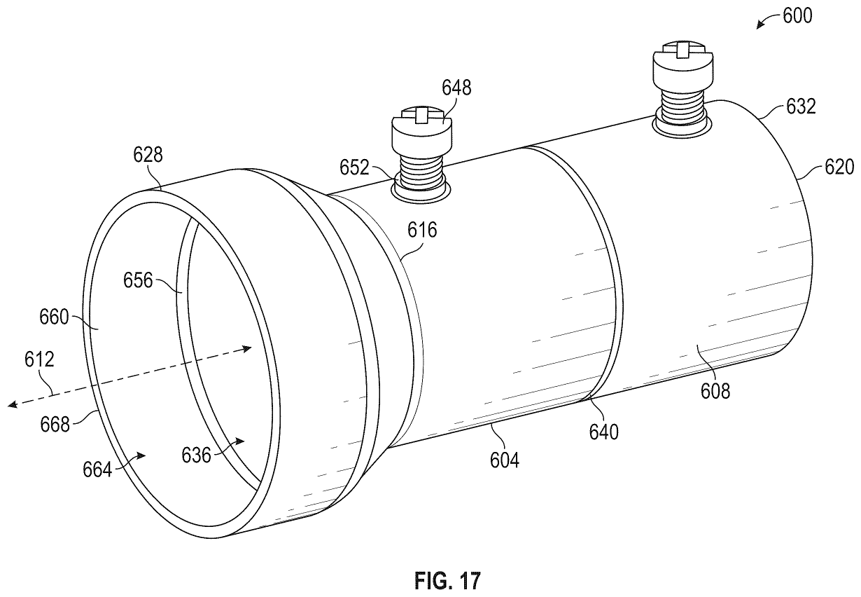

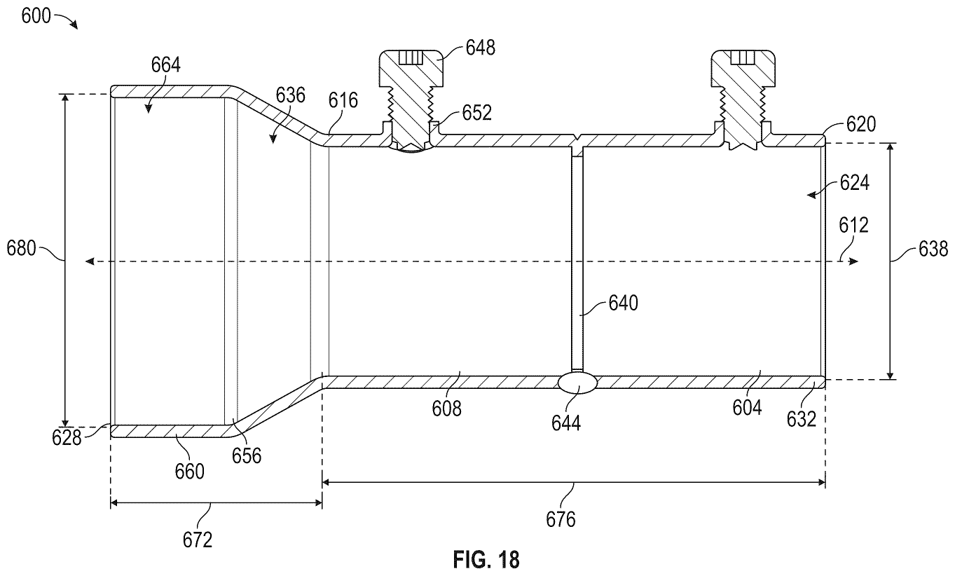

In some configurations, a coupler for receiving and retaining a length of conduit or other elongate structure, can include an alternate tapered entry extending from an end of the coupler to guide the end of a length of conduit into the coupler during installation. In this regard, for example, FIGS. 17 and 18 illustrate another embodiment of a coupler 600. The coupler 600 of FIGS. 17 and 18 may generally include similar features as the coupler 100 of FIGS. 1-3, including but not limited to a body 604, an exterior wall 608, a coupler center axis 612, a first coupler end 616, a second coupler end 620, an internal body passage 624, a first open end 628, a second open end 632, a tapered entry 636, an inner diameter 638, a coupler shoulder 640, an inspection opening 644, one or more fasteners 648, and one or more sets of fastener holes 652. Thus, discussion of the coupler 100 above also generally applies to similar components of the coupler 600 (and vice versa).

In some aspects, the couplers 100 and 600 may differ. For example, the tapered entry 636 of the coupler 600 of FIGS. 17 and 18 may extend axially from the first coupler end 116 to a tapered entry end 656. An insertion wall 660 defining an insertion passage 664 may extend axially opposite the first insertion direction from the tapered entry end 656, to an insertion opening 668 of the insertion passage 664. The insertion wall 660 may circumscribe an entirety of the tapered entry 636, and may be cylindrically shaped.

As shown in FIG. 18, a distance 672 between the first coupler end 616 and the insertion opening 668 may be about 40% of an axial length 676 of the body 804 (as measured at a bend between the tapered entry and the internal passage 624). In particular examples, distance 672 between the first coupler end 616 and the insertion opening 668 may be at least about 30% of the axial length 676 of the body 804.

The insertion wall 660 of the coupler 600 may define the insertion opening 668 for the insertion of the first length of conduit (not shown) in the first insertion direction. The insertion opening 668 may define an insertion (inner) diameter 680 that is larger than the opening (inner) diameter 638 of the first open end 628 of the coupler 600. In some embodiments, the insertion diameter 680 may be about 1.40 times greater than the opening diameter 680. In some embodiments, the insertion diameter 680 may be more than about 1.30 times greater than the opening diameter 638. In some embodiments, the insertion diameter 680 may be between about 1.6 (or about 1.20 or about 1.30) and about 2.70, inclusive, times greater than the opening diameter 638. The insertion diameter 680 of the insertion passage 664 that is larger than the opening diameter 638 of the coupler 600 may aid in guiding the insertion of the first length of conduit (not shown) into the coupler 600 during installation.

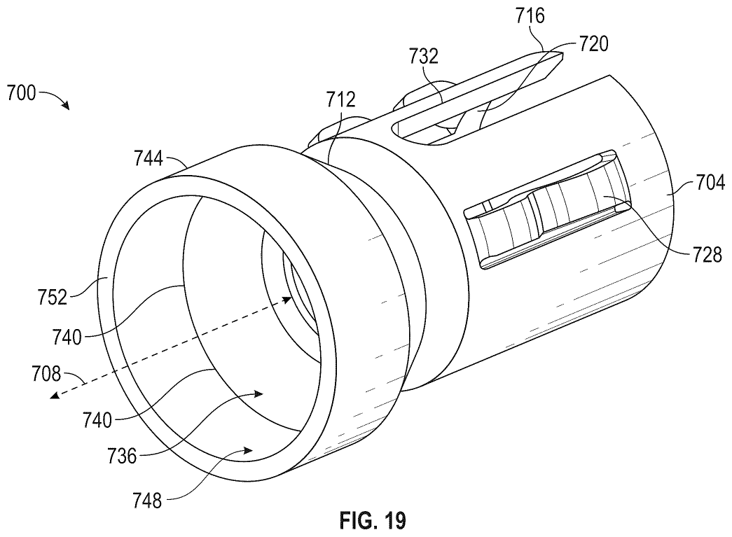

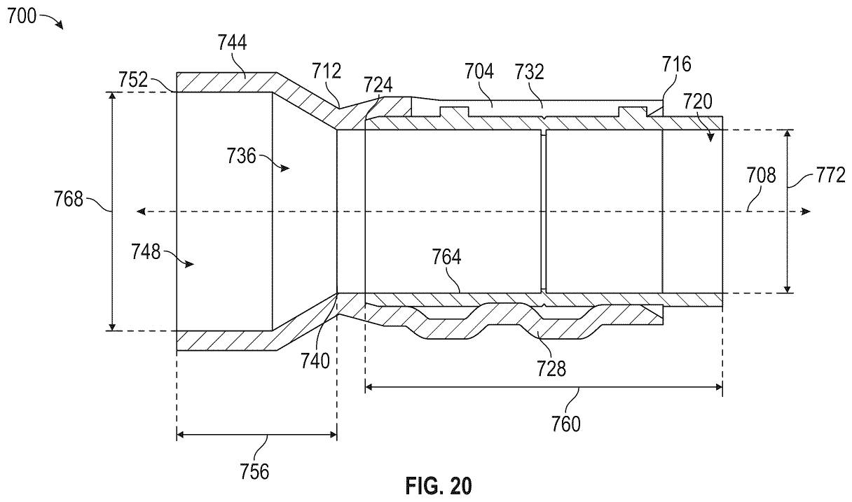

As described above, in some embodiments, a combination tapered entry and insertion passage may be non-integral with a coupler. In this regard, for example, FIGS. 19 and 20 illustrate another embodiment of an adapter 700. The adapter 700 of FIGS. 19 and 20 may generally include similar features as the adapter 200 of FIGS. 4-7, including but not limited to a sleeve 704, a sleeve center axis 708, a first sleeve end 712, a second sleeve end 716, an internal sleeve passage 720, a sleeve shoulder 724, one or more spring features 728, one or more elongate slots 732, and a tapered entry 736. Thus, discussion of the adapter 200 above also generally applies to similar components of the adapter 700 (and vice versa).

In some aspects, the adapters 200 and 700 may differ. For example, the adapter 700 may include the tapered entry 736 extending axially from the first sleeve end 712 to a tapered entry end 740. An insertion wall 744 defining an insertion passage 748 may extend axially opposite the first insertion direction from the tapered entry end 740 to an insertion opening 752 of the insertion passage 748. The insertion wall 744 may circumscribe an entirety of the tapered entry 736, and may be cylindrical in shape.

As shown in FIG. 20, a distance 756 between the first sleeve end 712 and the insertion opening 752 may be about 45% of an axial length 760 of a coupler 764 maintained within the adapter 1000. In some embodiments, distance 756 between the first sleeve end 712 and the insertion opening 752 may be at least about 35% of the axial length 760 of the coupler 764. In some embodiments, the distance 756 between the first sleeve end 712 and the insertion opening 752 may be about 45% between about 30% (or about 35% or about 40%) and about 55%, inclusive, of the axial length 760 of the coupler 764.

The insertion wall 744 of the adapter 1000 may define the insertion opening 752 for the insertion of the first length of conduit (not shown) in the first insertion direction. The insertion opening 752 may define an insertion (inner) diameter 768 that is larger than an inner diameter 772 of the coupler 764. In some embodiments, the insertion diameter 768 may be about 1.45 times greater than the inner diameter 772. In some embodiments, the insertion diameter 768 may be more than about 1.30 times greater than the inner diameter 772. In some embodiments, the insertion diameter 768 may be between about 1.10 (or about 1.20 or about 1.30) and about 2.70, inclusive, times greater than the inner diameter 772. The insertion diameter 768 of the insertion passage 748 that is larger than the inner diameter 772 of the coupler 764 may aid in guiding the insertion of the first length of conduit (not shown) into the coupler 764 during installation.

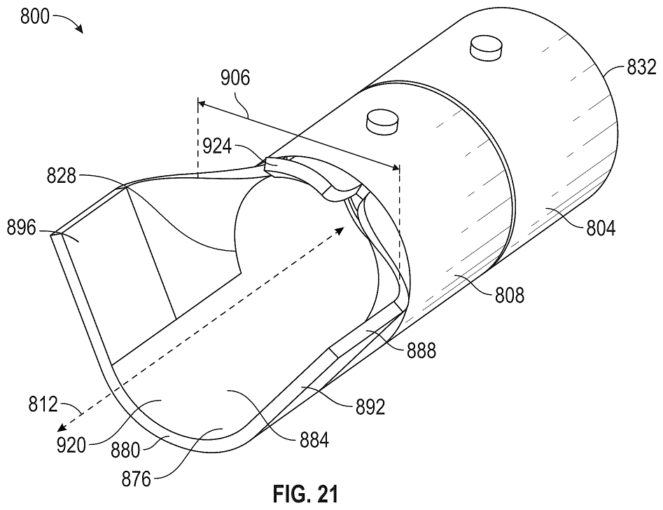

In some configurations, a coupler for receiving and retaining a length of conduit or other elongate structure, can include a tongue extending from an end of the coupler to guide the end of a length of conduit into the coupler during installation. In this regard, for example, FIGS. 21-23 illustrate another embodiment of a coupler 800. The coupler 800 of FIGS. 21-23 may generally include similar features as the coupler 100 of FIGS. 1-3, including but not limited to a body 804, an exterior wall 808, a coupler center axis 812, an internal body passage 824, a first coupler open end 828, a second coupler open end 832, an opening diameter 856, a coupler shoulder 860, an inspection opening 864, one or more fasteners 868, and one or more fastener holes 872. Thus, discussion of the coupler 100 above also generally applies to similar components of the coupler 800 (and vice versa).

In some aspects, the couplers 100 and 800 may differ. For example, the coupler 800 of FIGS. 21-23 includes a tongue 876 that may extend axially from the first open end 828 of the coupler 800. The tongue 876 may extend in a tongue direction opposite the first insertion direction, to a tongue end 880. In some embodiments, the tongue 876 may extend around less than a full perimeter (e.g., circumference) of the first open end 828. Specifically, the tongue 876 may generally be V-shaped, including a base 884 extending axially from the first coupler end 616, and wings that extend laterally (and upwardly) from the base 884 toward an open end 888 and corresponding free edges of the tongue 876 (e.g., of wings of the tongue 876, as further discussed below).

In some examples, the base 884 in particular may provide a landing surface for the lengths of conduit (not shown) that are to be inserted into the first open end 828 of the coupler 800. For example, the lengths of conduit (not shown) may be rested on the base 884 prior to moving the lengths of conduit (not shown) toward and into the internal body passage 824 of the coupler 800. In other words, the base 884—or the tongue 876 generally—can provide help installers to temporarily support and align the conduit for insertion into the internal body passage 824. Additionally, as illustrated in FIGS. 21-23, the base 884, and therefore the tongue 876, may extend integrally from the body 804. However, as discussed further below, in some embodiments, the tongue may not be integral with the body.

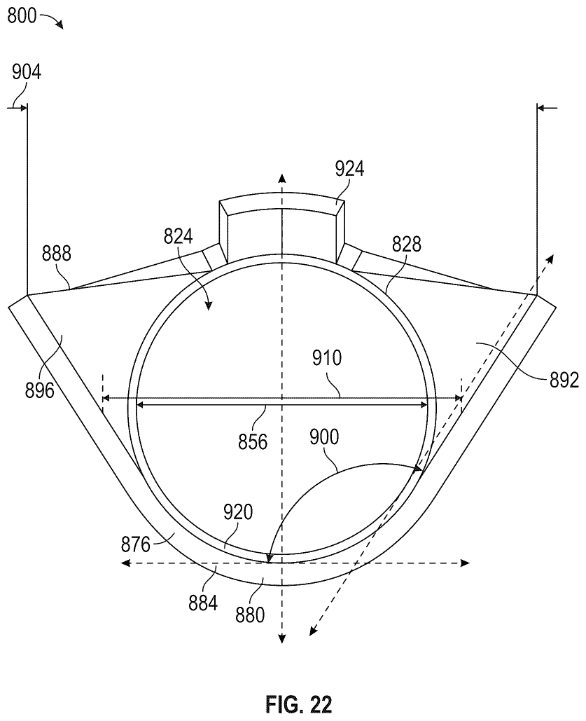

Referring to FIG. 22, the tongue 876 may include a first wing 892 and a second wing 896 that extend from the base 884 toward the open end 888 (and corresponding free edges of the wings). For example, the first wing 892 and the second wing 896 may each extend in a respective direction that is lateral and upward from the base 884. Additionally, the wings 892, 896 may extend symmetrically, relative to one another. The wings 892, 896 may also extend symmetrically relative to a first plane that extends radially from the coupler center axis 812 and that bisects the base 884.

In some examples, the first and second wings 892, 896 may each extend from the base 884 at a wing angle. In some examples, as shown in FIG. 22, a first wing angle 900 may be measured between the first wing 892 and a tangent extending radially from a center of the base 884 at the tongue end 880. For example, the first wing 892 may extend from the base 884 at the first wing angle 900 that is an oblique angle relative to the tangent line extending from a bottom point of the base 884. In other examples, the first wing angle 900, may similarly be measured between the first wing 892 and a second plane extending substantially perpendicular to the first plane (described above) at the tongue end 880 (e.g., along a tangent extending radially from a center of the base 884 at the tongue end 880). Utilizing either measurement style, the first wing angle 900 may be an oblique angle. Specifically, the first wing angle 900 may be about 120 degrees, when measured as shown in FIG. 22. In some examples, the wing angle may be at least about 90 degrees, or at least about 100 degrees, when measured as shown in FIG. 22. In some embodiments, the second wing 896 may extend at a second wing angle that is substantially similar to the first wing angle 900. In some embodiments, the second wing angle may alternatively be different than the first wing angle 900.

In some embodiments, an inner surface of the first wing 892 (e.g., a surface closest to the coupler center axis 812) may be flat. For example, the first wing 892 may be planar between a free end of the first wing 892 (e.g., an end of the first wing 892 at the open end 888 of the tongue 876), and the base 884. In some embodiments, each of the first wing 892 and the second wing 896 can be planar between free ends thereof and the base 884.

Still referring to FIG. 22, an open-end width 904 of the open end 888 of the tongue 876, measured between the free end of the first wing 892 and the free end of the second wing 896 at the tongue end 880, can be greater than the opening diameter 856 of the first open end 828. In some embodiments, the open-end width 904 may be about 1.40 times larger than the opening diameter 856. In some embodiments, the open-end width 904 may be more than about 1.3 times larger than the opening diameter 856. In some embodiments, the open-end width 904 may be between about 1.10 (or about 1.20 or about 1.30) and about 2.00, inclusive, times greater than the opening diameter 856. The open-end width 904 of the tongue 876 being larger than the opening diameter 856 of the first open end 828 may help guide the insertion of the first length of conduit (not shown) into the coupler 800 during installation.

Referring to FIGS. 21 and 22, in some embodiments, a width 906 of the tongue 876 measured between the free end of the first wing 892 and the free end of the second wing 896 may be variable (e.g., decrease) between the first open end 828 and the tongue end 880, along the first insertion direction. For example, the width 906 of the tongue 876 measured between the free end of the first wing 892 and the free end of the second wing 896 may decrease between the tongue end 880 and the first open end 828. As such, a width 906 between the free ends of the wings 892, 896 (e.g., at the open end 888 of the tongue 876) may taper inwardly, along the first insertion direction, between the open-end width 904 and the connections between the wings 892, 896 and the first open end 828. In some embodiments, aided by the taper of the wings 892, 896 in the first insertion direction, one or more of the wings 892, 896 may help to guide a length of conduit (not shown) into the first open end 828. Specifically, the length of conduit (not shown) having a laterally offset alignment relative to the first open end 828, may contact the wings 892, 896 and be guided toward a centered alignment relative to the first open end 828 as the conduit (not shown) is moved in the first insertion direction from the laterally offset alignment.

Still referring to FIG. 22, in some embodiments, a width 910 of the wings 892, 896 measured between opposing points on the first wing 892 and the second wing 896 may be variable between the open end 888 of the tongue 876 and the base 884 of the tongue 876. For example, the width 910 between the first wing 892 and the second wing 896 may be measured substantially parallel to the open-end width 904 (e.g., horizontally) at various heights above the base 884 of the tongue 876, between the open end 888 and the base 884. As illustrated in FIG. 22, the width 910 may decrease between the open end 888 and the base 884 of the tongue 876, from a perspective moving away from the open end 888 toward the base 884. As such, the wings 892, 896 may taper from the open end 888 to the base 884. Aided by the taper of the wings 892, 896, one or more of the wings 892, 896 may help to guide a length of conduit (not shown) into the first open end 828. Specifically, the length of conduit (not shown) having a laterally offset alignment relative to the first open end 828, may contact the wings 892, 896 and be guided toward a centered alignment relative to the first open end 828 as the conduit is lowered onto the one or more of the wings 892, 896 from the laterally offset alignment. Additionally, the taper of the wings 892, 896 may guide the length of conduit (not shown) toward the base 884 as well as toward the first open end 828.

Still referring to FIG. 22, in some embodiments, a maximum diameter of the open-end width 904 may be limited by a distance between a first and a second coupler (not shown) that are positioned adjacent to one another on a trapeze (not shown) or other support system. In such cases, the open-end width 904 of the first coupler (not shown) may be dimensioned such that the wings of the first coupler (not shown) do not interfere with the second coupler (not shown).

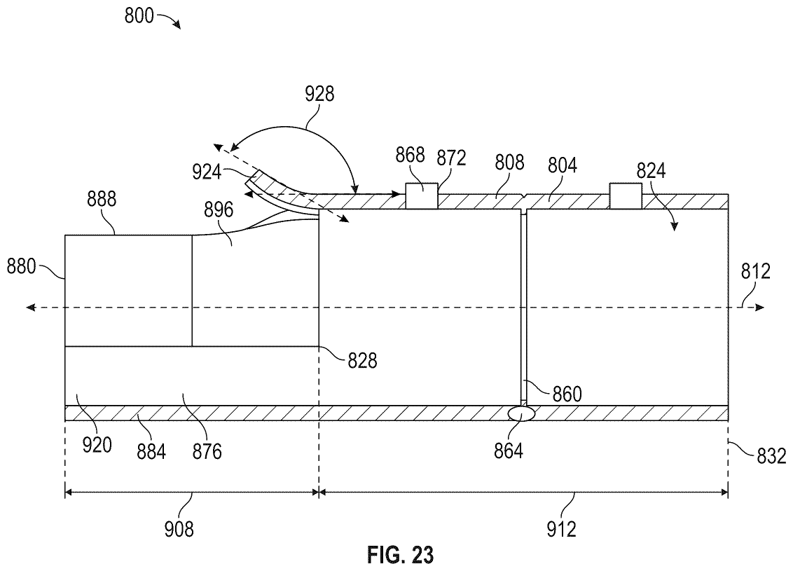

Referring to FIG. 23, a distance 908 between the tongue end 880 and the first open end 828 may be about 55% of an axial length 912 of the body 804. In some embodiments, the distance 908 between the tongue end 880 and the first open end 828 may be between about 40% (or about 45% or about 50%) and about 75%, inclusive, of the axial length 912 of the body 804. In some embodiments, the distance 908 between the tongue end 880 and the first open end 828 may be at least 10%, inclusive, of the axial length 912 of the body 804. In other examples, the distance 908 may be at least 20%, inclusive, of the axial length 912 of the body 804, or at least 30%, inclusive, of the axial length 912 of the body 804.

During installation, it can be advantageous to align tongue ends of two or more couplers (not shown) arranged on a strut or other support structure (not shown) on a same radial plane relative to insertion axes of the two or more couplers. In some embodiments, an axial length of a body may vary depending on a size of an opening diameter of a first end of the body. For example, a coupler including a relatively larger opening diameter may also include the body having a relatively longer axial length. In some embodiments, in order to ensure the tongue ends of two or more couplers (not shown) are aligned during installation, a length of a tongue of each coupler (not shown) may vary depending on a size of the opening diameter of each of the couplers (not shown).

A radially inner surface of the tongue 876 can provide a support surface 920—in particular, a landing surface along the base 884, for receiving and guiding a length of conduit (not shown) into the first open end 828 of the coupler 800. For example, the landing surface of the base 884, may be aligned and extend along a bottom portion of the support surface 920, with the support surface 920 also extending upwardly and outwardly onto the wings 892, 896.

Referring to FIG. 23, the support surface 920 (e.g., at the base 884) may be aligned with at least a portion of the internal body passage 824. For example, at least a portion of the support surface 920 including the base 884 may be co-radial with at least a portion of the internal body passage 824. Specifically, a radial distance between an inner wall of the internal body passage 824 and the coupler center axis 812, may be the same as or similar to a radial distance between at least a portion of the support surface 920 at the base 884 and the coupler center axis 812. In some embodiments, the entirety of the base 884 may be co-radial with the internal body passage 824. The support surface 920—and particularly the landing surface—being at least partially co-radial with the internal body passage 824 allows users to easily slide lengths of conduit (not shown) into the internal body passage 824 of the coupler 800 during installation.

In some embodiments, the coupler 800 includes a tab 924 extending from the first open end 828 in the tongue direction. The tab 924 may extend from the first open end 828, and may be disposed radially opposite the base 884. The tab 924 may extend at least partially from the first open end 828 to the tongue end 880. For example, the base 884 may extend farther in the tongue direction than the tab 924. The tab 924 may help guide the insertion of the length of conduit (not shown) into the coupler 800 during installation. Furthermore, the tab 924 may be configured to limit radial movement of a length of conduit (not shown) within the coupler 800 during installation. Specifically, the tab 924 may contact the length of conduit (not shown) during installation to ensure the length of conduit (not shown) does not lift off of the support surface 920 (e.g., the landing surface on the bas 884) and out of the open end 888.

In some embodiments, the tab 924 may be tapered. For example, the tab 924 may extend upwardly from the first open end 828 at a tab angle 928. The tab angle 928, measured between the exterior wall 808 and the tab 924, may be about 145 degrees. In some examples, the tab angle 928 may be at least about 135 degrees, or at least about 125 degrees.

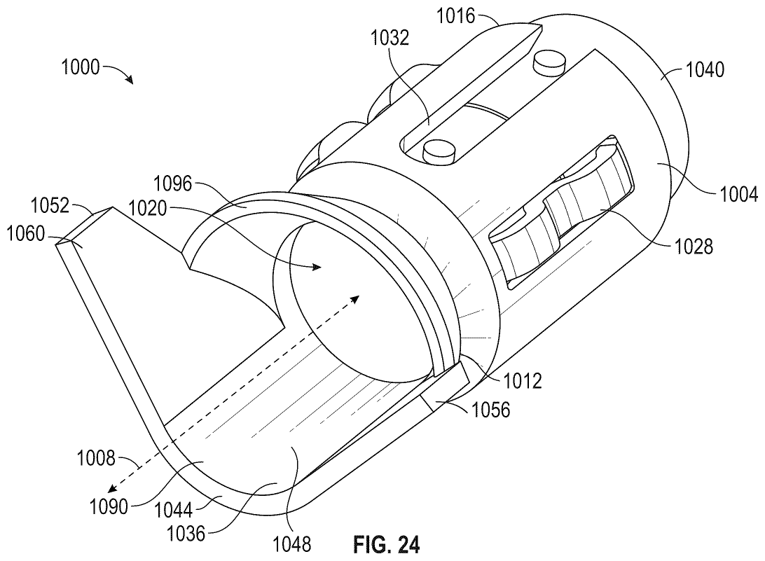

As described above, in some embodiments, the tongue may be non-integral with the coupler. In some embodiments, the tongue may extend from an adapter configured to be inserted onto or over the coupler. In this regard, for example, FIGS. 24-26 illustrate another embodiment of an adapter 1000. The adapter 1000 of FIGS. 24-26 may generally include similar features as the adapter 200 of FIGS. 4-7, including but not limited to a sleeve 1004, a sleeve center axis 1008, a first sleeve end 1012, a second sleeve end 1016, an internal sleeve passage 1020, a sleeve shoulder 1024, one or more spring features 1028, and one or more elongate slots 1032. Thus, discussion of the adapter 200 above also generally applies to similar components of the adapter 1000 (and vice versa).

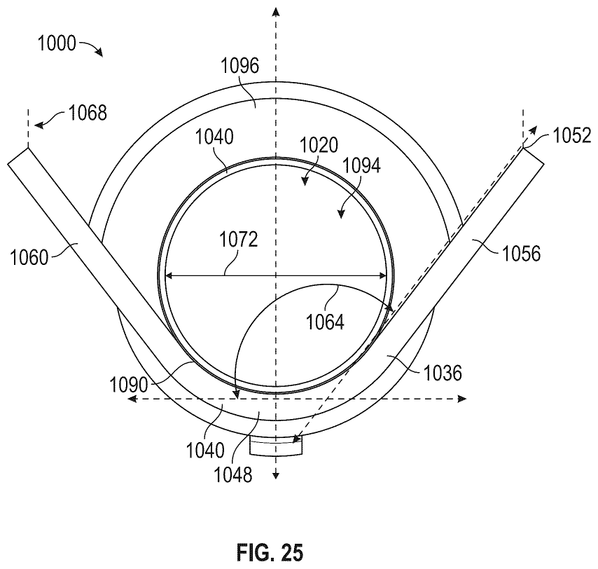

In some aspects, the adapters 200 and 1000 may be similar. For example, the base 1048 may be connected to a body of the coupler 1040 by inserting the coupler 1040 into the internal sleeve passage 1020 of the adapter 1000. However, in some aspects, the adapters 200 and 1000 may differ. For example, the adapter 1000 of FIGS. 24-26 may include a tongue 1036 to help guide conduit for insertion into a coupler 1040, similarly to the tongue 876 described above. The tongue 1036 may extend axially from the first sleeve end 1012. The tongue 1036 may extend in a tongue direction opposite the first insertion direction, toward a tongue end 1044. In some embodiments, the tongue 1036 may extend around less than a full circumference of the first sleeve end 1012. For example, the tongue 1036 may generally be V-shaped, including a base 1048 extending axially from the first sleeve end 1012, and wings that extend laterally from the base 1048 toward an open end 1052. As illustrated in FIG. 25 the base 1048 may extend integrally from the first sleeve end 1012 to provide a landing surface for the lengths of conduit (not shown) that are inserted into an open end of the coupler 1040. In some examples, the tongue 1036 may exhibit the same particular or relative geometry as the tongue 876 (and vice versa), and discussion above regarding the tongue 876 can thus also apply to the tongue 1036 (and vice versa).

Referring to FIG. 25, the tongue 1036 may include a first wing 1056 and a second wing 1060 that extend from the base 1048 toward the open end 1052. For example, the first wing 1056 and the second wing 1060 may extend in a direction that is laterally outward and upward from the base 1048. Additionally, the wings 1056, 1060 may extend symmetrically, relative to one another. The wings 1056, 1060 may also extend symmetrically relative to a first plane that extends radially from the sleeve center axis 1008 and that bisects the base 1048.

The first and second wings 1056, 1060 may each extend at an at a wing angle. In some examples, a first wing angle 1060 may be measured between the first wing 1056 and a tangent extending radially from a center of the base 1048 at the tongue end 1064. For example, the first wing 1056 may extend from the base 1048 at the first wing angle 1064 that is an oblique angle relative to the tangent line extending from a bottom point of the base 1048. In other examples, the first wing angle 1064, may similarly be measured between the first wing 1056 and a second plane extending substantially perpendicular to the first plane (described above) at the tongue end 1044. Utilizing either measurement style, the first wing angle 1064 may be an oblique angle.

Specifically, the first wing angle 900 may be about 130 degrees as measured relative to the tangent line or first plane. In some examples, the wing angle 1064 may be at least about 100 degrees, or at least about 110 degrees. The second wing 1060 may extend at a second wing angle that is substantially similar to the first wing angle 1064. In some embodiments, the second wing angle may alternatively be different than the first wing angle 1064.

Still referring to FIG. 25 an open-end width 1068 of the open end 1052 of the tongue 1036, measured between a free end of the first wing 1056 and a free end of the second wing 1060 at the tongue end 1044, can be greater than an opening (inner) diameter 1072 of the coupler 1040. In some embodiments, the open-end width 1068 may be about 2.20 times greater than the opening diameter 1072. In some embodiments, the open-end width 1068 may be more than about 2.00 times greater than the opening diameter 1072. In some embodiments, the open-end width 1068 may be between about 1.20 (or about 1.50 or about 2.00) and about 2.60, inclusive, times greater than the opening diameter 1072. The open-end width 1068 of tongue that is larger than the opening diameter 1072 of the coupler 1040 may aid in guiding the insertion of the first length of conduit (not shown) into the coupler 1040 during installation. Furthermore, similar to the wings 892, 896, the wings 1056, 1060 may taper between the free ends of the wings 1056, 1060 and the base 1048.

Still referring to FIG. 25, in some embodiments, a maximum diameter of the open-end width 1068 may be limited by a distance between a first and a second coupler (not shown) positioned adjacent to one another on a trapeze (not shown) or other support system. In such cases, the open-end width 1068 of a first adapter (not shown), inserted over the first coupler (not shown), may be dimensioned such that the wings of the first adapter (not shown) do not interfere with the second coupler (not shown).

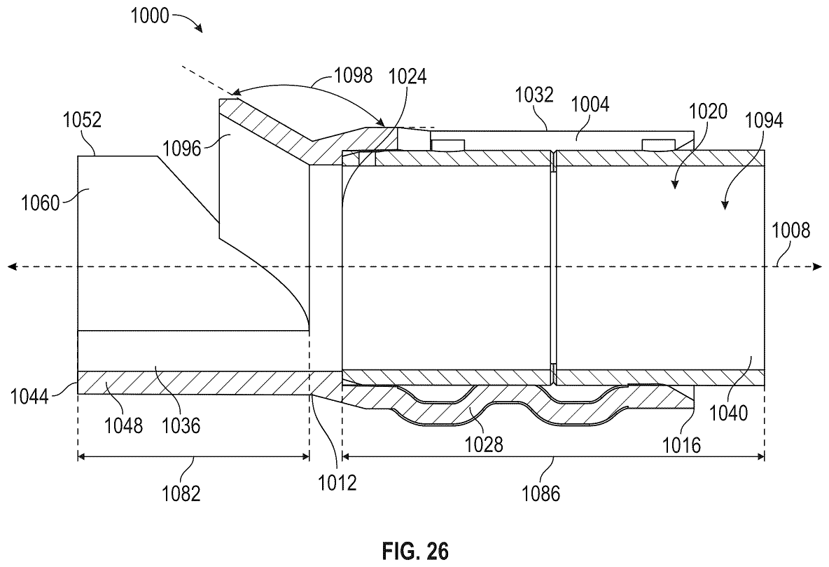

As illustrated in FIG. 26, a distance 1082 between the tongue end 1044 and the first sleeve end 1012 may be about 50% of an axial length 1086 of the coupler 1040. In some embodiments, the distance 1082 between the tongue end 1044 and the first sleeve end 1012 may be between about 35% (or about 40% or about 45%) and about 60%, inclusive, of the axial length 1086 of the coupler 1040.

A radially inner surface of the tongue 1036 can provide a support surface 1090 for receiving and guiding a length of conduit (not shown) into the coupler 1040, including with a landing surface at a base of the support surface 1090 in some cases. Still referring to FIG. 26, at least a portion of the support surface 1090 (e.g., at the landing surface along the base 1048) may be co-radial with at least a portion of an internal body passage 1094 of the coupler 1040 (similar to the internal passage 124). Specifically, a radial distance between an inner wall of the internal body passage 1094 and the sleeve center axis 1008, may be the same as or similar to a radial distance between at least a portion of the support surface 1090 of the base 1048 and the sleeve center axis 1008. In some embodiments, the entirety of the base 1048 may be co-radial with the internal body passage 1094. The support surface 1090 being at least partially co-radial with the internal body passage 1094 allows users to easily slide lengths of conduit (not shown) into the internal body passage 1094 of the coupler 1040 during installation.

In some embodiments, the coupler 1040 includes a tab 1096 or tapered entry extending from the first open end 828 in the tongue direction. The tab 1096 may extend from the first sleeve end 1012, and may be disposed radially opposite the base 1048. The tab 1096 may extend at least partially from the first sleeve end 1012 to the tongue end 1044. In some embodiments, the tab 1096 may extend circumferentially around the first sleeve end 1012 to connect with the first and second wings 1056, 1060 of the tongue 1036. The tab 1096 may help guide the insertion of the length of conduit (not shown) into the coupler 1040 during installation. Furthermore, during installation the tab 1096 may be configured to limit radial movement of a length of conduit (not shown). Specifically, the tab 1096 may contact the length of conduit (not shown) during installation to ensure the length of conduit (not shown) does not exit the coupler 1040 via the open end 1052.

In some embodiments, the tab 1096 may be tapered. For example, the tab 1096 may extend upwardly from the first sleeve end 1012 at a tab angle 1098. The tab angle 1098, measured between the sleeve 1004 and the tab 1096, may be about 150 degrees. In some examples, the tab angle 1098 may be at least about 140 degrees, or at least about 130 degrees.

In some embodiments, the wings 1056, 1060 may be connected to the tab 1096. Additionally, in some embodiments, a width of the tongue 1036 measured between the free end of the first wing 1056 and the free end of the second wing 1060 may be variable between tab 1096 and the tongue end 1044. For example, the width of the tongue 1036 measured between the free end of the first wing 1056 and the free end of the second wing 1060 may decrease between the tongue end 1044 and the connection between the wings 1056, 1060 and the tab 1096. As such, a width between the free ends of the wings 1056, 1060 (e.g., at the open end 1052 of the tongue 1036) may taper inwardly, along the insertion direction, between the open-end width 1068 and the connection between the wings 1056, 1060 and the tab 1096.

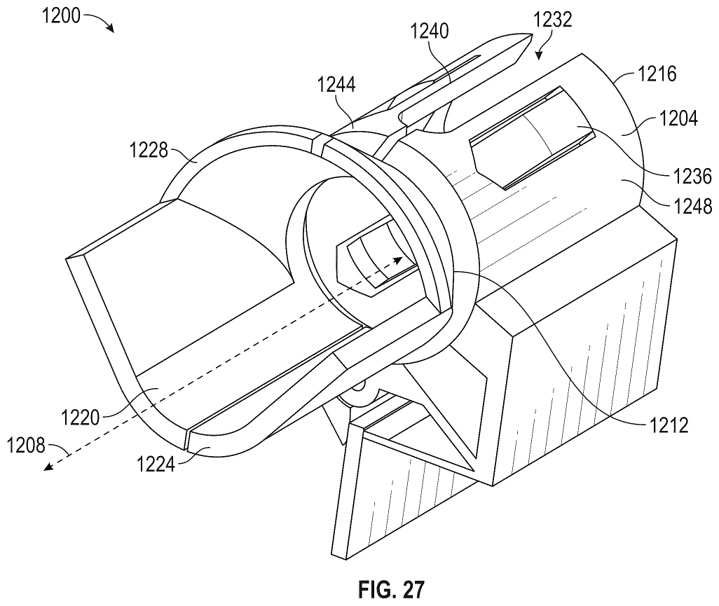

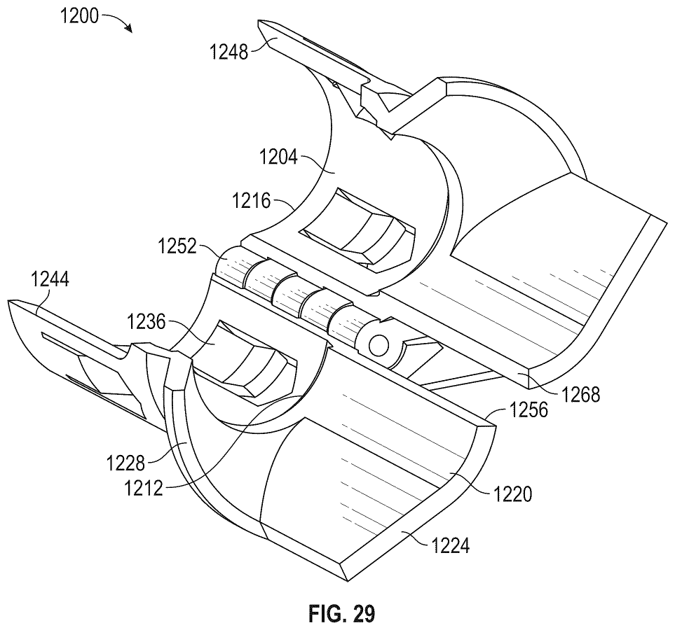

In some configurations, a multi-piece adapter (e.g., tongued adapter) can be configured to be installable around and removable from a conduit coupler. In this regard, for example, FIGS. 27-29 illustrate another embodiment of an adapter 1200. The adapter 1200 of FIGS. 23-26 may generally include similar features as the adapter 1200 of FIGS. 20-22, including but not limited to a sleeve 1204, a sleeve center axis 1208, a first sleeve end 1212, a second sleeve end 1216, a tongue 1220, a tongue end 1224, a tab 1228, an internal sleeve passage 1232, one or more spring features 1236, and one or more elongate slots 1240. Thus, discussion of the adapter 1000 above also generally applies to similar components of the adapter 1200 (and vice versa).

The adapter 1200 of FIGS. 27-29 may also generally include similar features as the adapter 500 of FIGS. 12-16, including but not limited to a first adapter body 1244 and a second adapter body 1248. Thus, discussion of the adapter 500 above also generally applies to similar components of the adapter 1200.

Referring to the adapter 1200 illustrated in FIGS. 27-29, the first adapter body 1244 and the second adapter body 1248 are configured to be removably secured together. In some configurations, the first adapter body 1244 may be a first half of the adapter 1200 and the second adapter body 1248 may be a second half of the adapter 1200. Specifically, the first adapter body 1244 may include first portions of the sleeve 1204, the tongue 1220, and the tab 1228. Furthermore, the second adapter body 1248 may include second portions of the sleeve 1204, the tongue 1220, and the tab 1228.

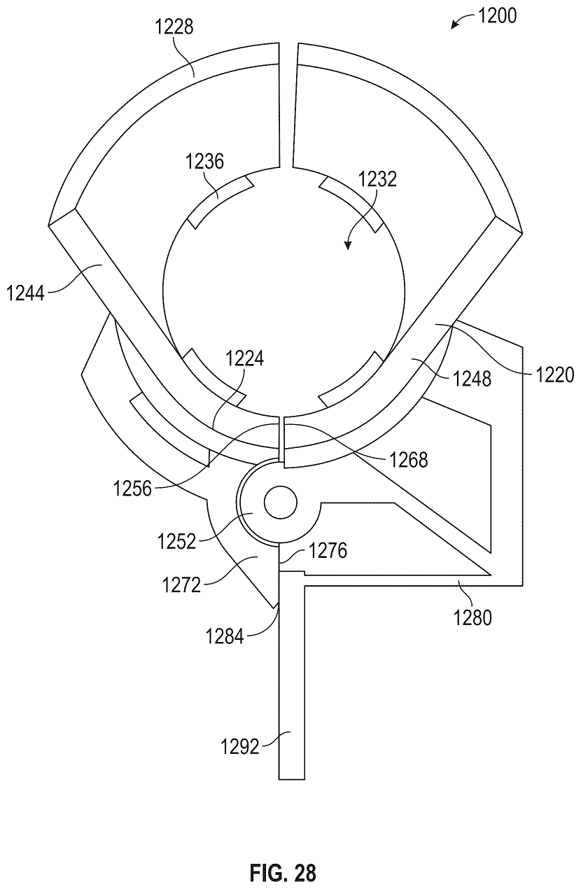

Referring specifically to FIG. 28, similar to the adapter 500, the adapter 1200 may further include a hinge 1252 connecting the first adapter body 1244 and the second adapter body 1248. A first edge 1256 of the first adapter body 1244 may extend axially from the second sleeve end 1216 to the tongue end 1224. A third edge 1268 of the second adapter body 1248 may extend axially from the second sleeve end 1216 to the tongue end 1224. A first portion of the hinge 1252 may extend from the first edge 1256. A second portion of the hinge 1252 may extend from the third edge 1268. The hinge 1252 may connect the first edge 1256 to the third edge 1268, to allow the adapter 1200 to hingedly open and close.

Still referring to FIG. 28, a catch 1272 may extend from the first adapter body 1244 circumferentially around the hinge 1252. The catch 1272 may include a first face 1276 that protrudes radially over the hinge 1252. As described below, the first face 1276 of the catch 1272 may be configured to engage a latch 1280.

In some embodiments, the latch 1280 may extend from the second adapter body 1248 around the hinge 1252. The latch may include a second face 1284 that extends radially from the latch 1280 along the sleeve center axis 1208. As illustrated in FIG. 28, the first face 1276 of the catch 1272 may engage the second face 1284 of the latch 1280. The engagement of the latch 1280 and the catch 1272 may secure the first adapter body 1244 and the second adapter body 1248 together. Thus, secured together, the first adapter body 1244 and the second adapter body 1248 may accordingly form the internal sleeve passage 1232 and the tongue 1220.

Referring to FIGS. 27 and 28, the latch 1280 may include a grip 1292. The grip 1292 may extend away from the second face 1284, and exerting a pulling force on the grip 1292 may release the latch 1280 from the catch 1272. In some embodiments, the one or more spring features 1236 of the adapter 1200 may aid the opening of the adapter 1200. Specifically, the adapter 1200 may be pushed into an open configuration when the one or more spring features 1236 resiliently return to a non-deformed configuration. Furthermore, similar to the adapter 500, as the first adapter body 1244 and the second adapter body 1248 are connected via the hinge 1252, the adapter 1200 may be removed and installed as a singular piece, reducing the complexity of installation and removal.

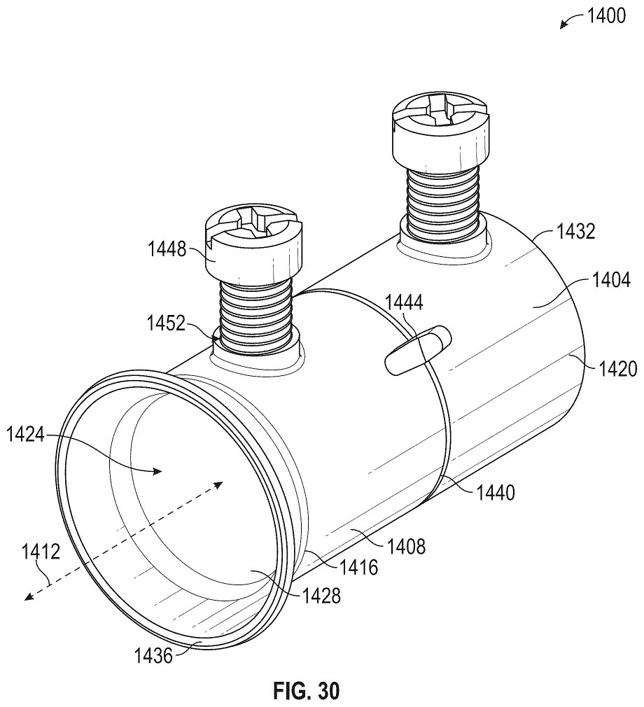

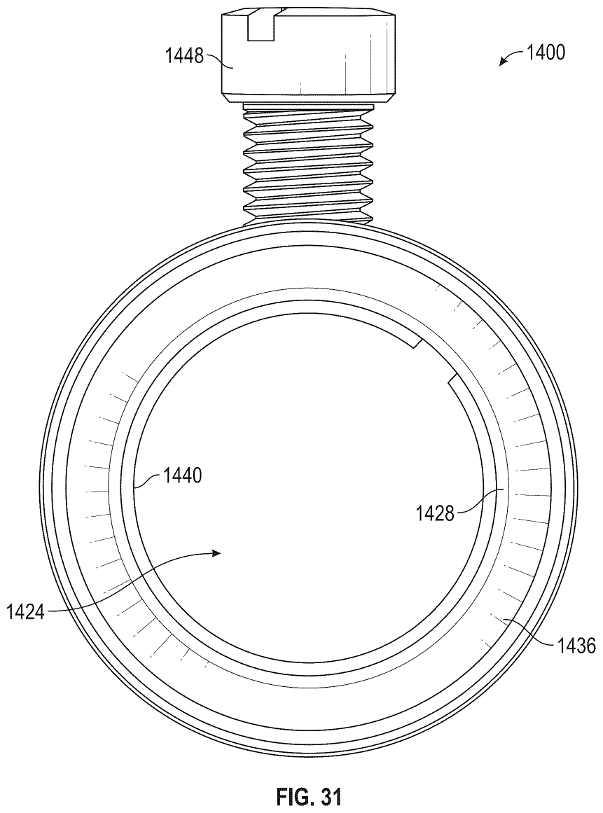

In some configurations, a coupler for receiving and retaining a length of conduit or other elongate structure, can include an alternate style of an inspection opening or other coupler feature as compared to those discussed above. In this regard, for example, FIGS. 30-32 illustrate another embodiment of a coupler 1400. The coupler 1400 of FIGS. 30-32 may generally include similar features as the coupler 100 of FIGS. 1-3, including but not limited to a body 1404, an exterior wall 1408, a coupler center axis 1412, a first coupler end 1416, a second coupler end 1420, an internal body passage 1424, a first open end 1428, a second open end 1432, a tapered entry 1436, a coupler shoulder 1440, an inspection opening 1444, one or more fasteners 1448, and one or more sets of fastener holes 1452. Thus, discussion of the coupler 100 above also generally applies to similar components of the coupler 600 (and vice versa).

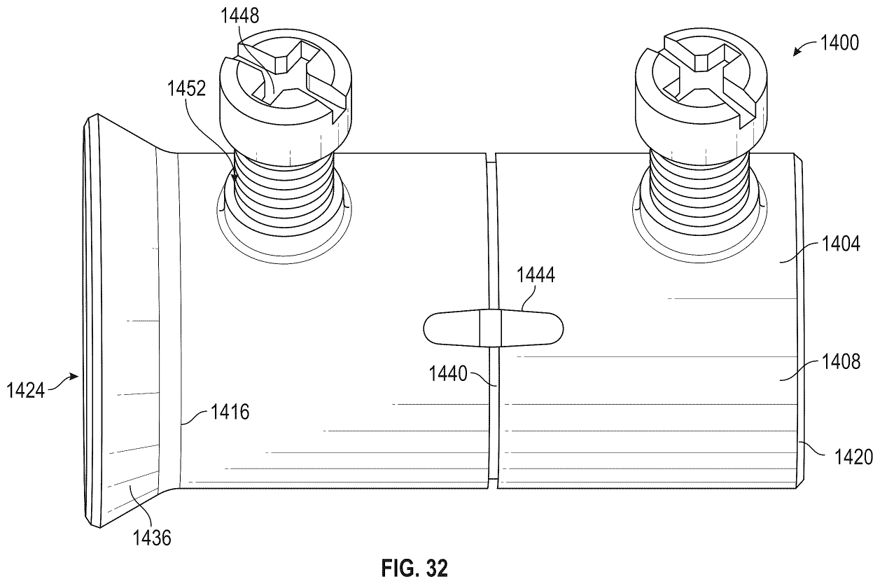

In some aspects, the couplers 100 and 1400 may differ. For example, the inspection opening 1444 may define an alternate perimeter shape as compared to the inspection opening 164. As illustrated in FIG. 32, the perimeter shape of the inspection opening 1444 may be oblong. Specifically, the perimeter shape of the inspection opening 1444 may be ovular in shape, and a longest dimension of the inspection opening 1444 may extend substantially parallel to the coupler center axis 1412. In other examples, the inspection opening 1444 may instead be any oblong shape such as a rectangle, a diamond, or other oblong shape. As the inspection opening 1444 (e.g., a center thereof) is aligned on and extends across the coupler shoulder 1440, elongating the inspection opening 1444 in parallel with the coupler center axis 1412 may provide better visual access to verify that an end of both the first and second conduits (not shown) are properly inserted within the internal body passage 124, and contacting the coupler shoulder 160.

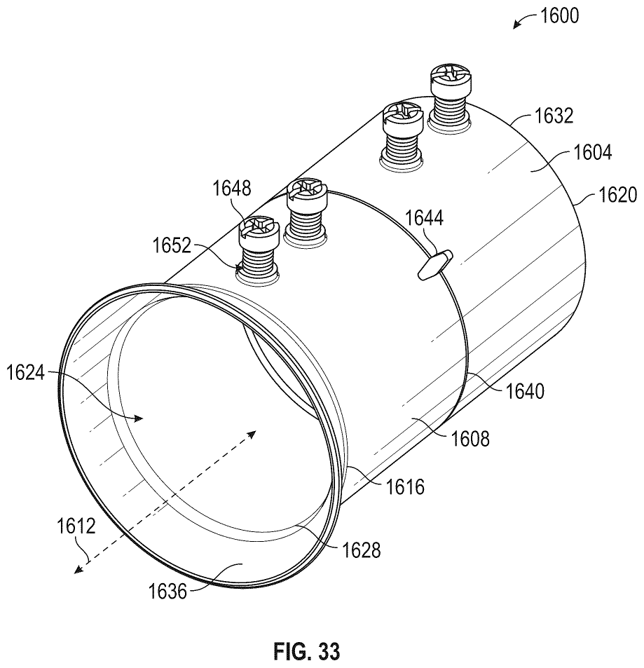

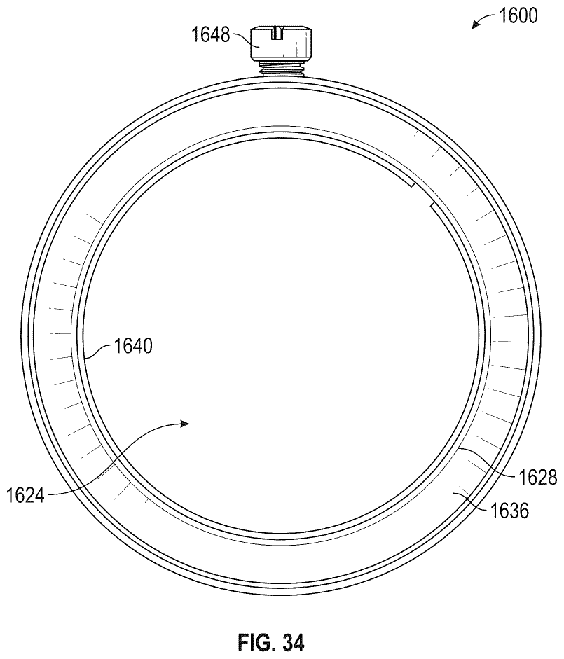

In some configurations, a coupler for receiving and retaining a length of conduit or other elongate structure, can include a greater number of fasteners for securing first and second lengths of conduit within the coupler than in examples discussed above. In this regard, for example, FIGS. 33-35 illustrate another embodiment of a coupler 1600. The coupler 1600 of FIGS. 33-35 may generally include similar features as the coupler 100 of FIGS. 1-3, including but not limited to a body 1604, an exterior wall 1608, a coupler center axis 1612, a first coupler end 1616, a second coupler end 1620, an internal body passage 1624, a first open end 1628, a second open end 1632, a tapered entry 1636, a coupler shoulder 1640, an inspection opening 1644, one or more fasteners 1648, and one or more sets of fastener holes 1652. Thus, discussion of the coupler 100, 1400 above also generally applies to similar components of the coupler 1600 (and vice versa).

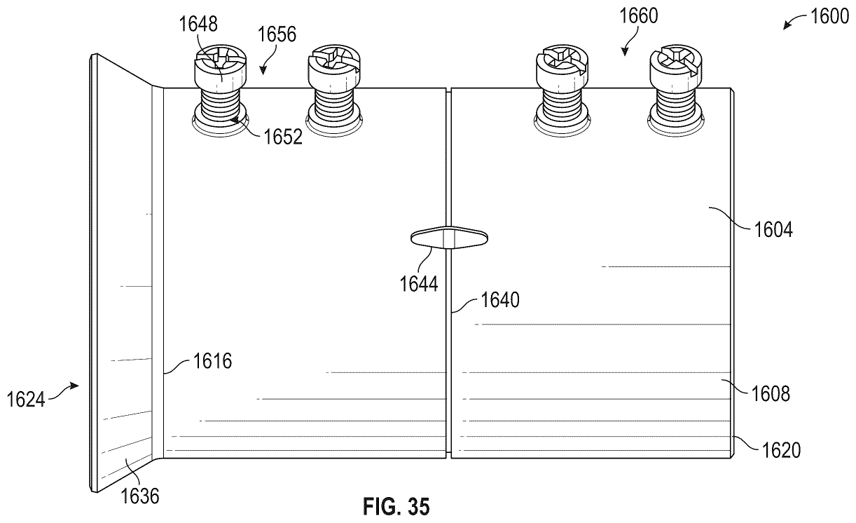

In some aspects, the couplers 100 and 1600 may differ. For example, the coupler 1600 may include at least four of the fasteners 1648 for securing the first and second lengths of conduit (not shown) within the body passage 1624. As illustrated in FIG. 35, a first set 1656 of the fasteners 1648, including two or more of the fasteners 1648, may extend through the exterior wall 1608 into the internal body passage 1624, to aid in the securing of the first length of conduit (not shown), within the internal body passage 124. Similarly, a second set 1660 of the fasteners 168 may extend through the exterior wall 108 into the internal body passage 124, to aid in the securing of the second length of conduit (not shown), within the internal body passage 124, opposite the first length of conduit (not shown). Increasing a number of the fasteners 1648 used for securing the first and second lengths of conduit (not shown) may help to mitigate unwanted movement of the lengths of conduit after installation. Additionally, increasing a number of the fasteners 1648 used for securing the first and second lengths of conduit (not shown) may be especially useful when securing lengths of conduit having a larger diameter.

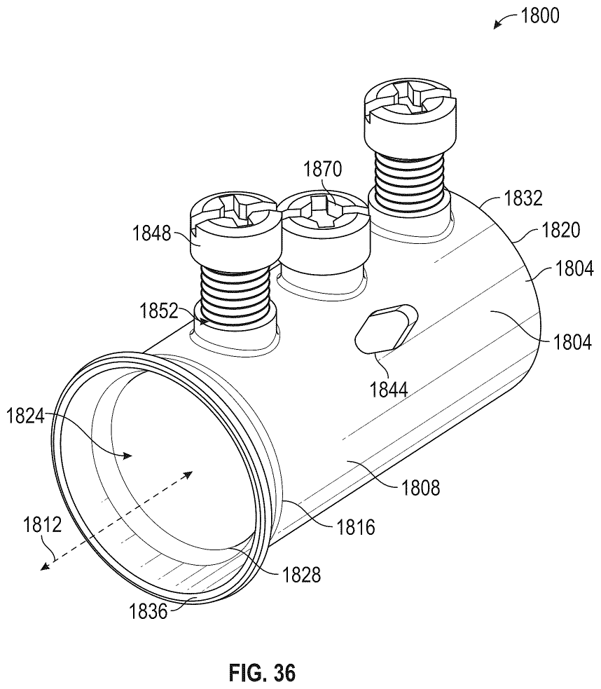

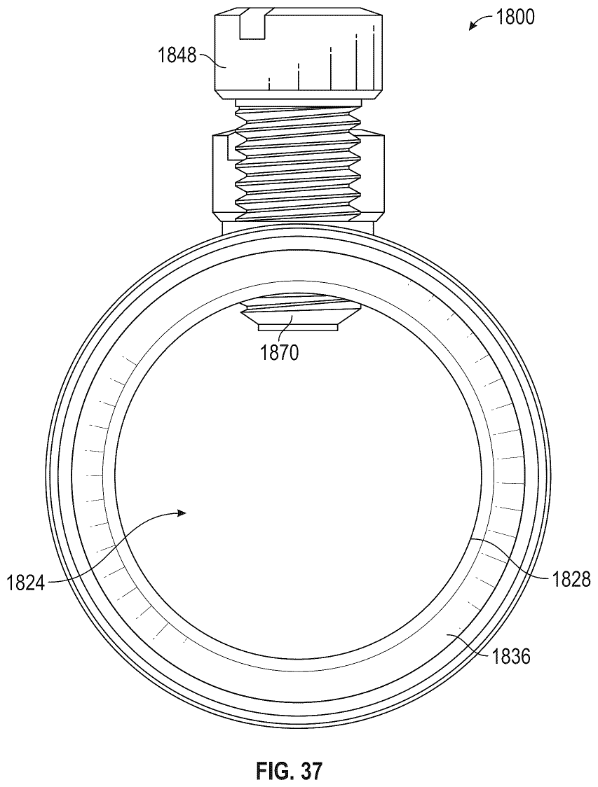

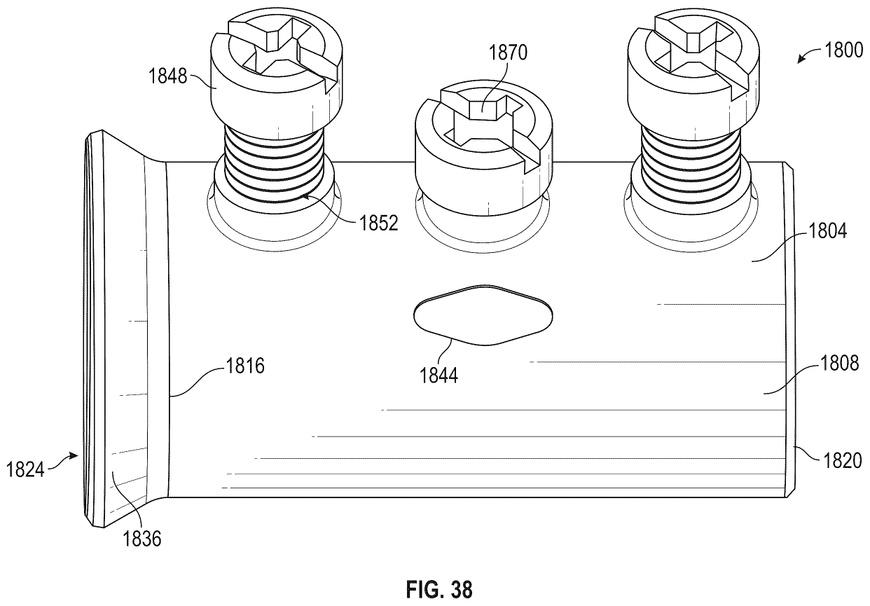

In some configurations, a coupler for receiving and retaining a length of conduit or other elongate structure, can include an alternate style inspection opening. In this regard, for example, FIGS. 36-38 illustrate another embodiment of a coupler 1800. The coupler 1800 of FIGS. 36-38 may generally include similar features as the coupler 100 of FIGS. 1-3 and the coupler 1400 of FIGS. 30-32, including but not limited to a body 1804, an exterior wall 1808, a coupler center axis 1812, a first coupler end 1816, a second coupler end 1820, an internal body passage 1824, a first open end 1828, a second open end 1832, a tapered entry 1836, an inspection opening 1844, one or more fasteners 1848, and one or more sets of fastener holes 1852. Thus, discussion of the coupler 100, 1400 above also generally applies to similar components of the coupler 1800 (and vice versa).

In some aspects, the couplers 100, 1400 and 1800 may differ. For example, the coupler 1800 may not include a coupler shoulder. The coupler 1800 may instead include a stop fastener 1870. The stop fastener 1870 may extend through the exterior wall 1808 of the coupler 1800, into the internal body passage 1824. So arranged, the stop fastener 1870 may provide a contact stop for the first length of conduit (not shown) inserted in the first insertion direction, and the second length of conduit (not shown) inserted in the second direction. Thus, the stop fastener 1870 may prevent over insertion of the lengths of the conduit (not shown) within the coupler 1800. In some examples, the stop fastener may be disposed about halfway between the first coupler end 1816 and the second coupler end 1820 of the coupler 1800. In the illustrated example, the stop fastener 1870 may be a screw. However, in other examples, other fastener types may provide a contact stop for the lengths of conduit (not shown), including various pins or other non-threaded fasteners.

As similarly discussed above, the inspection opening 1844 may provide visual access to the first and second conduit (not shown) installed within the internal body passage 1824. The inspection opening 1844 may therefore allow an installer to visually verify that an end of the first and second conduit (not shown) are properly inserted within the internal body passage 1824, contacting the stop fastener 1870.

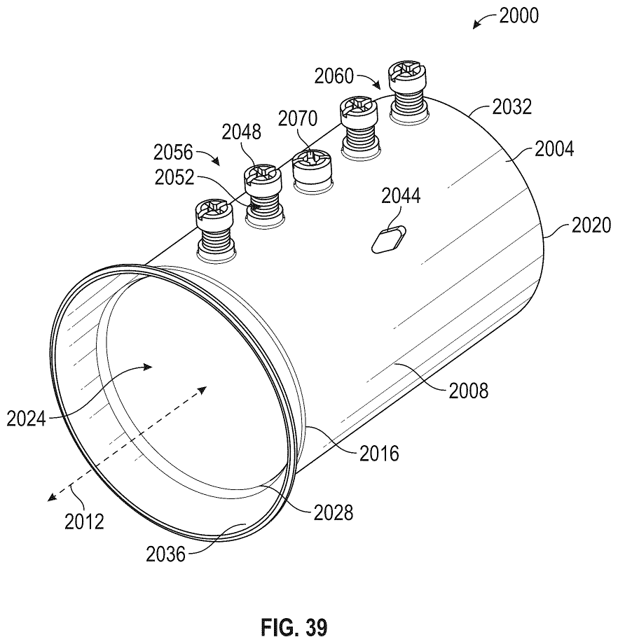

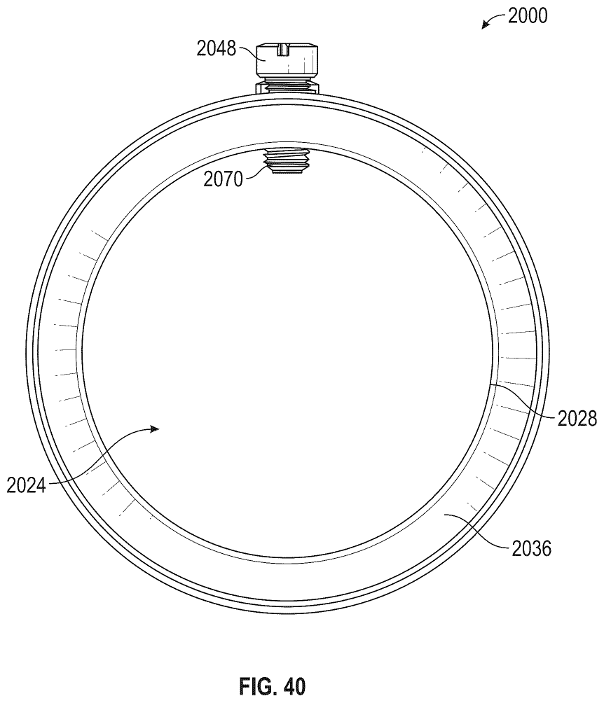

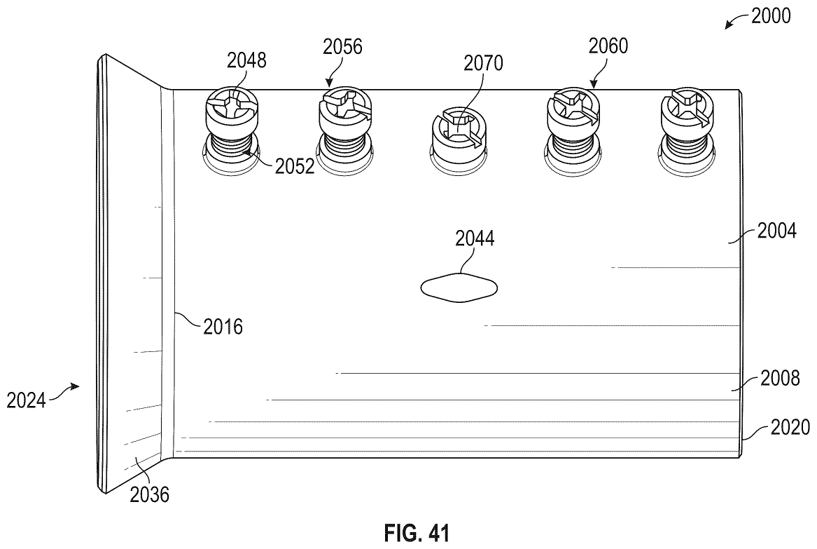

In some configurations, such a coupler for receiving and retaining a length of conduit or other elongate structure, can include a greater number of fasteners for securing first and second lengths of conduit within the coupler than presented above. In this regard, for example, FIGS. 39-41 illustrate another embodiment of a coupler 2000. The coupler 2000 of FIGS. 49-41 may generally include similar features as the coupler 100 of FIGS. 1-3, the coupler 1600 of FIGS. 33-35, and the coupler 1800 of FIGS. 36-38, including but not limited to a body 2004, an exterior wall 2008, a coupler center axis 2012, a first coupler end 2016, a second coupler end 2020, an internal body passage 2024, a first open end 2028, a second open end 2032, a tapered entry 2036, an inspection opening 2044, one or more fasteners 2048 including a first set of 2056 of the fasteners 2048 and a second set 2060 of the fasteners 2048, one or more sets of fastener holes 2052, as well as a stop fastener 1870. Thus, discussion of the coupler 100, 1400, 1600 above also generally applies to similar components of the coupler 2000 (and vice versa).

As discussed above, with respect to FIGS. 33-35 the coupler 2000 may include at least four of the fasteners 1648 for securing the first and second lengths of conduit (not shown) within the body passage 1624. For example, the coupler 2000 can include the first set 2056 of the fasteners 2048 extending through the exterior wall 2008 into the internal body passage 2024, to aid in the securing of the first length of conduit (not shown), within the internal body passage 2024. The coupler 2000 can further include the second set 2060 of the fasteners 2048 that extend through the exterior wall 2008 into the internal body passage 2024, to aid in the securing of the second length of conduit (not shown), within the internal body passage 2024, opposite the first length of conduit (not shown). Additionally, the coupler 2000 may include the stop fastener 2070 (e.g., instead of a coupler shoulder).

Thus, examples of the disclosed technology can provide improved systems for installing conduit and piping. Some examples provide a coupler or adapter with a tapered entry that is inexpensive to manufacture while providing an improved mechanism for aligning conduit during installation. Further, some examples may provide an improved method for reusing an adapter with a tapered entry to reduce cost and waste associated with the installation of conduit.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, the terms “about” and “approximately,” as used herein with respect to a reference value, refer to variations from the reference value of ±20% or less (e.g., ±15, +10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

We claim:

1. A coupler for joining conduit, the coupler comprising:
a body defining an internal body passage that includes a first open end to receive a first conduit in a first axial insertion direction and a second open end to receive a second conduit in a second axial insertion direction opposite the first axial insertion direction; and
a tongue extending from a first axial end of the body in a tongue direction, opposite the first axial insertion direction, to provide a support surface that extends axially away from the first open end of the internal body passage in the tongue direction, including a landing surface at a bottom portion of the support surface and wings extending upwardly and laterally outwardly from the landing surface, the tongue extending around less than a full perimeter of the first open end and the wings extending laterally wider than the first open end.

2. The coupler of claim 1, wherein the tongue extends from the first open end, by at least 10% of an axial length of the body.

3. The coupler of claim 1, wherein the wings include a first wing and a second wing that extend symmetrically relative to one another.

4. The coupler of claim 3, wherein the first wing and the second wing extend from the landing surface at an oblique angle relative to a tangent line at a bottom point on the landing surface.

5. The coupler of claim 4, wherein the first and second wings are planar between free ends thereof and the landing surface.

6. The coupler of claim 1, wherein a distance between a free end of a first wing of the wings and a free end of a second wing of the wings is greater than a diameter of the first open end.

7. The coupler of claim 1, wherein an inspection opening extends radially through an exterior wall that defines the internal body passage to provide visual access to at least one of the first and second conduit within the internal body passage.

8. The coupler of claim 1, further comprising a tab extending from the first open end in the tongue direction, on an opposite side of the first open end from the landing surface.

9. The coupler of claim 8, wherein the landing surface extends farther in the tongue direction than the tab.

10. The coupler of claim 1, wherein the landing surface extends co-radially with at least a bottom portion of the internal body passage at the first open end.

11. The coupler of claim 10, wherein the wings taper inwardly, along the insertion direction, from distal ends thereof to connections between the wings and the first axial end of the body.

12. The coupler of claim 11, wherein the first axial end of the body includes a tapered entry extending in the tongue direction from the first open end;
wherein the wings include top free edges; and
wherein the top free edges taper inwardly to connect to a distal end of the tapered entry.

13. The coupler of claim 1, wherein the landing surface is integral with the body.

14. The coupler of claim 1, wherein the landing surface extends integrally from a sleeve of an adapter that defines an internal sleeve passage; and
wherein the body is received into the internal sleeve passage to secure the landing surface to the body.

15. A method of connecting a first conduit to a second conduit, the method comprising:
connecting the first conduit to a body of a coupler by extending the first conduit into an internal body passage that is defined by the body, with the coupler inserted in a first axial insertion direction into a first open end of the internal body passage at a first axial end of the body, the body further including a second open end of the internal body passage at a second axial end of the body opposite the first axial end, the second open end defining a second axial insertion direction opposite the first axial insertion direction; and
connecting the second conduit to the coupler by:
resting the second conduit on a landing surface of the coupler that is included on a tongue that extends from the second axial end of the body in a tongue direction that is opposite the second axial insertion direction; and
moving the second conduit from the landing surface in the second axial insertion direction, to extend the second conduit into the internal body passage of the coupler at the second open end,
the second conduit being guided to one or more of the landing surface or the second open end by wings of the coupler that extend upwardly from the landing surface and laterally outwardly from the landing surface to be laterally wider than the second open end.

16. The method of claim 15, wherein the second conduit is guided from the landing surface to the second open end by a tab extending from the second open end in the tongue direction, on an opposite side of the second open end from the landing surface.

17. The method of claim 15, wherein a width between the wings tapers from a top to bottom perspective, so that one or more of the wings guide the second conduit from a laterally offset alignment relative to the second open end toward a centered alignment relative to the second open end as the conduit is lowered onto the one or more of the wings from the laterally offset alignment.

18. The method of claim 17, wherein the width between wings tapers from a perspective along the second insertion direction, so that one or more of the wings guide the second conduit from the laterally offset alignment toward the centered alignment as the conduit is moved in the second insertion direction from the laterally offset alignment.

19. The method of claim 15, further comprising:
connecting the landing surface to the body by inserting the body into an internal sleeve of an adapter that includes the landing surface.

20 A. coupler for joining conduit, the coupler comprising:
a body that includes an exterior wall surrounding an internal body passage, the internal body passage including a first open end to receive a first conduit in a first axial insertion direction and a second open end to receive a second conduit in a second axial insertion direction;
a tapered entry extending from the first open end; and
a cylindrical insertion passage extending from the tapered entry, opposite the first open end, with a greater internal width than the first open end;
the tapered entry extending from the first open end, in a direction opposite the first axial insertion direction; and
the insertion passage extending from the tapered entry, in a direction opposite the first axial insertion direction.
